(19) United States
(12) Patent Application Publication
(10) Pub. No.: US 2025/0123652 A1
(43) Pub. Date: Apr. 17, 2025

(54) CLOCK SELECTION CIRCUIT, DISPLAY DEVICE INCLUDING THE SAME, AND METHOD OF DRIVING THE SAME

(71) Applicant: Samsung Display Co., LTD., Yongin-si (KR)

(72) Inventors: Kyung Ho KIM, Yongin-si (KR); Sang Yong NO, Yongin-si (KR); Sung Yoon HWANG, Yongin-si (KR)

(21) Appl. No.: 18/908,204

(22) Filed: Oct. 7, 2024

(30) Foreign Application Priority Data
Oct. 11, 2023 (KR) 10-2023-0135415

(51) Int. Cl. G06F 1/08

(52) U.S. Cl. CPC G06F 1/08

(57) ABSTRACT

According to one or more embodiments of the present disclosure, a clock selection circuit includes an inverter configured to receive an input signal through a first input terminal, and at least one controller configured to receive at least one clock signal and configured to output the clock signal when the input signal is supplied to the inverter.

### CROSS-REFERENCE TO RELATED APPLICATION

The present application claims priority to and the benefit of Korean Patent Application No. 10-2023-0135415, filed on Oct. 11, 2023, in the Korean Intellectual Property Office, the entire disclosure of which is incorporated by reference herein.

### BACKGROUND

### 1. Field

The present disclosure relates to a clock selection circuit, a display device including the same, and a method of driving the same.

### 2. Description of the Related Art

As information society develops, a demand for a display device for displaying an image is increasing in various forms. For example, the display device is being applied to various electronic devices such as a smart phone, a digital camera, a notebook computer, a navigation device, and a smart television.

The display device displays an image using pixels. The display device may include a plurality of scan drivers and emission drivers to drive the pixels.

### SUMMARY

Aspects and features of embodiments of the present disclosure are to provide a clock selection circuit capable of reducing or minimizing power consumption, a display device including the same, and a method of driving the same.

According to one or more embodiments of the present disclosure, a clock selection circuit includes an inverter configured to receive an input signal through a first input terminal, and at least one controller configured to receive at least one clock signal and configured to output the clock signal when the input signal is supplied to the inverter.

According to one or more embodiments, the inverter includes a P-type first transistor and an N-type second transistor connected in series between a first power source and a second power source having a voltage lower than that of the first power source, and a gate electrode of the first transistor and a gate electrode of the second transistor are connected to the first input terminal.

According to one or more embodiments, the controller includes a first transmission gate connected between a first output terminal and a second input terminal connected to a first clock line configured to receive a first clock signal, the first transmission gate includes a P-type third transistor and an N-type fourth transistor connected in parallel between the second input terminal and the first output terminal, a gate electrode of the third transistor is connected to a first node which is a common node of the first transistor and the second transistor, and a gate electrode of the fourth transistor is connected to the first input terminal.

According to one or more embodiments, when the input signal is input to the first input terminal, the third transistor and the fourth transistor are turned on, and when the input signal is not supplied, the third transistor and the fourth transistor are turned off.

According to one or more embodiments, the controller further includes a second transmission gate connected between a second output terminal and a third input terminal connected to a second clock line configured to receive a second clock signal, the second transmission gate includes a P-type fifth transistor and an N-type sixth transistor connected in parallel between the third input terminal and the second output terminal, and a gate electrode of the fifth transistor is connected to the first node, and a gate electrode of the sixth transistor is connected to the first input terminal.

According to one or more embodiments, when the input signal is input to the first input terminal, the fifth transistor and the sixth transistor are turned on, and when the input signal is not supplied, the fifth transistor and the sixth transistor are turned off.

According to one or more embodiments of the present disclosure, a display device includes pixels connected to scan lines, emission control lines, and data lines, a scan driver configured to supply a scan signal to the scan lines, an emission driver configured to supply an emission control signal to the emission control lines, and a clock controller configured to receive at least one clock signal to drive the scan driver, and configured to determine whether to supply the clock signal to the scan driver in response to the emission control signal.

According to one or more embodiments, the clock controller is configured to sequentially receive the emission control signal in a horizontal line unit, and configured to output the clock signal in the horizontal line unit in response to the emission control signal.

According to one or more embodiments, the clock controller includes a plurality of clock selection circuits, the scan driver includes a plurality of stage circuits, and an i-th (i is a natural number) clock selection circuit at an i-th horizontal line is configured to supply the clock signal to an i-th stage circuit at the i-th horizontal line when the emission control signal is supplied to the i-th emission control line.

According to one or more embodiments, the i-th clock selection circuit does not supply the clock signal to the i-th stage circuit when the emission control signal is not supplied to the i-th emission control line.

According to one or more embodiments, the i-th clock selection circuit includes a first input terminal connected to the i-th emission control line, an inverter connected to the first input terminal, and a controller connected to the first input terminal and a first node which is an output node of the inverter, and configured to supply the clock signal to the i-th stage circuit when the emission control signal is supplied to the first input terminal.

According to one or more embodiments, the inverter includes a P-type first transistor and an N-type second transistor connected in series between a first power source and a second power source having a voltage lower than that of the first power source, and a gate electrode of the first transistor and a gate electrode of the second transistor are connected to the first input terminal.

According to one or more embodiments, the controller includes a first transmission gate connected between a first output terminal and a second input terminal connected to a first clock line configured to receive a first clock signal is input, the first transmission gate includes a P-type third transistor and an N-type fourth transistor connected in parallel between the second input terminal and the first output terminal, a gate electrode of the third transistor is connected to the first node, and a gate electrode of the fourth transistor is connected to the first input terminal.

According to one or more embodiments, the first clock signal is supplied to the i-th stage circuit via the first output terminal when the first transmission gate is turned on.

According to one or more embodiments, the controller further includes a second transmission gate connected between a second output terminal and a third input terminal connected to a second clock line configured to receive a second clock signal, the second transmission gate includes a P-type fifth transistor and an N-type sixth transistor connected in parallel between the third input terminal and the second output terminal, a gate electrode of the fifth transistor is connected to the first node, and a gate electrode of the sixth transistor is connected to the first input terminal.

According to one or more embodiments, the second clock signal is supplied to the i-th stage circuit via the second output terminal when the second transmission gate is turned on.

According to one or more embodiments, the scan lines include first scan lines and second scan lines respectively at the horizontal lines, and the scan driver includes a first scan driver configured to drive the first scan lines, and a second scan driver for driving the second scan lines.

According to one or more embodiments, the clock signal includes at least one write clock signal for driving the first scan driver and at least one compensation clock signal for driving the second scan driver.

According to one or more embodiments, the clock controller includes a plurality of clock selection circuits, the first scan driver includes a plurality of write stage circuits, the second scan driver includes a plurality of compensation stage circuits, and when the emission control signal is supplied to an i-th (i is a natural number) emission control line, an i-th clock selection circuit at an i-th horizontal line is configured to supply the write clock signal to an i-th write stage circuit positioned on the i-th horizontal line, and supplies the compensation clock signal to an i-th compensation stage circuit at the i-th horizontal line.

According to one or more embodiments, when the emission control signal is not supplied to the i-th emission control line, the i-th clock selection circuit does not supply the write clock signal to the i-th write stage circuit and does not supply the compensation clock signal to the i-th compensation stage circuit.

According to one or more embodiments, the i-th clock selection circuit includes a first input terminal connected to the i-th emission control line, an inverter connected to the first input terminal, a first controller connected to the first input terminal and a first node which is an output node of the inverter, and is configured to supply the write clock signal to the i-th write stage circuit when the emission control signal is supplied to the first input terminal, and a second controller connected to the first input terminal and the first node, and is configured to supply the compensation clock signal to the i-th compensation stage circuit when the emission control signal is supplied to the first input terminal.

According to one or more embodiments, the inverter includes a P-type first transistor and an N-type second transistor connected in series between a first power source and a second power source having a voltage lower than that of the first power source, and a gate electrode of the first transistor and a gate electrode of the second transistor is connected to the first input terminal.

According to one or more embodiments, the first controller includes a first transmission gate connected between a first output terminal and a second input terminal connected to a first clock line configured to receive a first write clock signal, and is configured turn on when the emission control signal is supplied to the first input terminal, and a second transmission gate connected between a second output terminal and a third input terminal connected to a second clock line configured to receive a second write clock signal, and turn on when the emission control signal is supplied to the first input terminal.

According to one or more embodiments, the second controller includes a first transmission gate connected between a first output terminal and a second input terminal connected to a first clock line configured to receive a first compensation clock signal, and is configured to turn on when the emission control signal is supplied to the first input terminal, and a second transmission gate connected between a second output terminal and a third input terminal connected to a second clock line configured to receive a second compensation clock signal, and is configured to turn on when the emission control signal is supplied to the first input terminal.

According to one or more embodiments of the present disclosure, a display device includes pixels connected to first scan lines, second scan lines, emission control lines, and data lines, a first scan driver configured to supply a first scan signal to the first scan lines, a second scan driver configured to supply a second scan signal to the second scan lines, an emission driver configured to supply an emission control signal to the emission control lines, a first clock controller configured to receive at least one write clock signal to drive the first scan driver and is configured to determine whether to supply the write clock signal in response to the second scan signal, and a second clock controller configured to receive at least one compensation clock signal for driving the second scan driver and id configured to determine whether to supply the compensation clock signal in response to the emission control signal.

According to one or more embodiments, the first clock controller is further configured to sequentially receive the second scan signal in a horizontal line unit, and configured to output the write clock signal in the horizontal line unit in response to the second scan signal.

According to one or more embodiments, the first clock controller includes a clock selection circuit at the horizontal line, and an i-th (i is a natural number) clock selection circuit at an i-th horizontal line includes an inverter configured to output by inverting an i-th second scan signal, and a controller configured to output the write clock signal to the first scan driver when the i-th second scan signal and an output signal of the inverter are input, and does not output the write clock signal in other cases.

According to one or more embodiments, the second clock controller is further configured to sequentially receive the emission control signal in a horizontal line unit and configured to output the compensation clock signal in the horizontal line unit in response to the emission control signal.

According to one or more embodiments, the second clock controller includes a clock selection circuit at the horizontal line, and an i-th (i is a natural number) clock selection circuit at an i-th horizontal line includes an inverter configured to output by inverting an i-th emission control signal, and a controller configured to output the compensation clock signal to the second scan driver when the i-th emission control signal and an output signal of the inverter are input, and does not output the compensation clock signal in other cases.

According to one or more embodiments of the present disclosure, a method of driving a display device includes sequentially supplying an emission control signal to pixels, outputting a clock signal in a horizontal line unit when the emission control signal is input, and sequentially supplying a scan signal in response to the clock signal input in the horizontal line unit.

Aspects and features of embodiments of the present disclosure are not limited to the aspects and features described above, and other technical aspects and features which are not described will be clearly understood by those skilled in the art from the following description.

In accordance with the clock selection circuit, the display device including the same, and the method of driving the same according to one or more embodiments of the present disclosure, power consumption may be reduced by selectively supplying a clock to the scan driver.

However, effects, aspects, and features of the present disclosure are not limited to the above-described effects, aspects, and features and may be variously extended within a range that does not deviate from the spirit and scope of the present disclosure.

### BRIEF DESCRIPTION OF DRAWINGS

The above and other features of the present disclosure will become more apparent by describing in further detail embodiments thereof with reference to the accompanying drawings, in which:

FIG. 1 is a diagram illustrating a display device according to one or more embodiments of the present disclosure;

FIG. 2 is a diagram illustrating an embodiment of a clock controller shown in FIG. 1;

FIG. 3 is a circuit diagram illustrating an embodiment of a clock selection circuit shown in FIG. 2;

FIG. 4 is a diagram illustrating an embodiment of the clock selection circuit and a stage circuit;

FIG. 5 is a waveform diagram illustrating an embodiment of a method of driving the clock selection circuit;

FIG. 6 is a diagram illustrating an example of a pixel shown in FIG. 1;

FIG. 7 is a waveform diagram illustrating an example of a method of driving the pixel shown in FIG. 6;

FIG. 8 is a diagram illustrating an embodiment of a scan driver shown in FIG. 1;

FIG. 9 is a diagram illustrating an embodiment of a clock controller shown in FIG. 8;

FIG. 10 is a diagram illustrating an embodiment of a clock selection circuit shown in FIG. 9;

FIG. 11 is a diagram illustrating an embodiment of the scan driver and the clock controller of FIG. 1;

FIG. 12 is a circuit diagram illustrating an embodiment of a clock selection circuit included in each of a first clock controller and a second clock controller; and

FIGS. 13A and 13B are diagrams illustrating an embodiment of the clock selection circuit and the stage circuit of the display device of FIG. 1.

### DETAILED DESCRIPTION

Hereinafter, various embodiments of the present disclosure will be described in detail with reference to the accompanying drawings so that those skilled in the art may easily carry out the present disclosure. The present disclosure may be implemented in various different forms and is not limited to embodiments described herein.

In order to clearly describe the present disclosure, parts that are not related to the description are omitted, and the same or similar elements are denoted by the same reference numerals throughout the specification. Therefore, the above-described reference numerals may be used in other drawings.

In addition, because a size and a thickness of each configuration shown in the drawings are arbitrarily shown for convenience of description, the present disclosure is not necessarily limited to that shown in the drawings. In order to clearly express a plurality of layers and areas in the drawing, a thickness may be exaggerated.

In addition, an expression “is the same” in the description may mean “is substantially the same”. That is, the expression “is the same” may be the same enough for those of ordinary skill to understand that it is the same. Other expressions may also be expressions in which “substantially” is omitted.

Some embodiments are described in the accompanying drawings in relation to functional block, unit, and/or module. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the spirit and scope of the present disclosure. In addition, in some embodiments, the block, unit and/or module may be physically combined into more complex blocks, units, and/or modules without departing from the spirit and scope of the present disclosure.

A term “connection” between two configurations may mean that both of an electrical connection and a physical connection are used inclusively, but is not limited thereto. For example, “connection” used based on a circuit diagram may mean an electrical connection, and “connection” used based on a cross-sectional view and a plan view may mean a physical connection.

Although a first, a second, and the like are used to describe various components, these components are not limited by these terms. These terms are used only to distinguish one component from another component. Therefore, a first component described below may be a second component within the technical spirit of the present disclosure. The singular expression includes the plural expression unless the context clearly dictates otherwise.

The present disclosure is not limited to embodiments disclosed below, and may be modified in various forms and may be implemented. In addition, each of the embodiments disclosed below may be implemented alone or in combination with at least one of other embodiments.

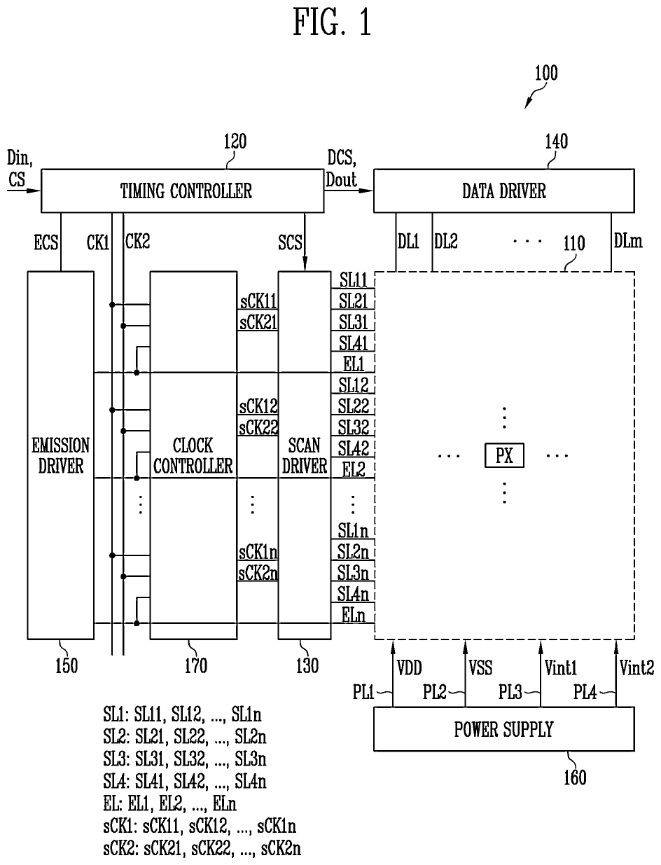

FIG. 1 is a diagram illustrating a display device according to one or more embodiments of the present disclosure.

Referring to FIG. 1, the display device 100 according to one or more embodiments of the present disclosure may include a pixel unit 110 (or a display panel), a timing controller 120, a scan driver 130, a data driver 140, an emission driver 150, a power supply 160, and a clock controller 170.

The pixel unit 110 may include pixels PX connected to first scan lines SL1: SL11, SL12, . . . , and SL1n, second scan lines SL2: SL21, SL22, . . . , and SL2n, third scan lines SL3: SL31, SL32, . . . , and SL3n, fourth scan lines SL4: SL41, SL42, . . . , and SL4n, data lines DL1, DL2, . . . , and DLm, emission control lines EL: EL1, EL2, . . . , and ELn, and power lines PL1, PL2, PL3, and PL4 (here, n and m are natural numbers). Here, the pixels PX may be a sub-pixel.

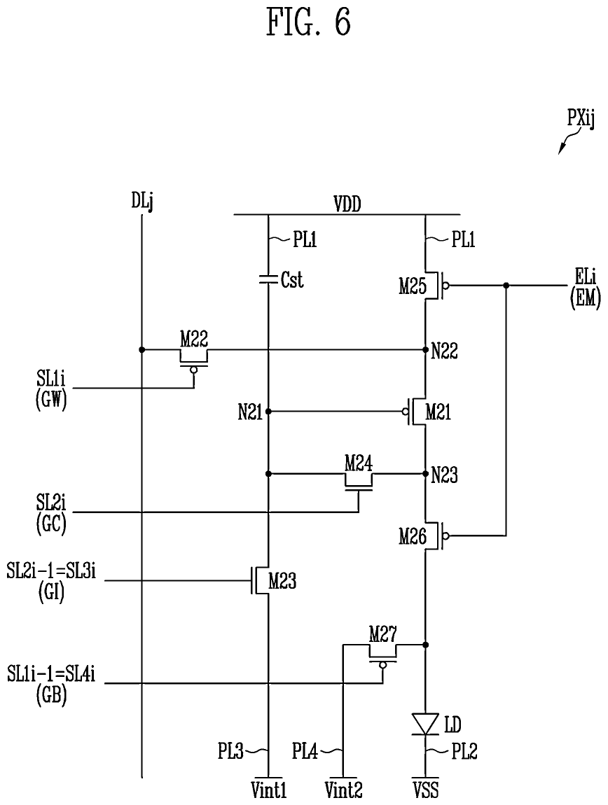

For example, a pixel PXij (refer to FIG. 6) positioned on an i-th horizontal line (or pixel row) and a j-th vertical line (or pixel column) may be connected to an i-th first scan line SL1i, an i-th second scan line SL2i, an i-th third scan line SL3i, an i-th fourth scan line SL4i, an i-th emission control line ELi, and a j-th data line DLj (here, i is n natural number equal to or less than n, and j is a natural number equal to or less than m).

When an enable first scan signal is supplied to first scan lines SL1: SL11 to SL1n, the pixels PX may be selected in a horizontal line unit (for example, the pixels PX connected to the same scan line may be classified into one horizontal line (or pixel row)), and the pixels PX selected by the enable first scan signal may receive a data signal from a data line (any one of DL1 to DLm) connected thereto. The pixels PX receiving the data signal may generate light of a desired luminance (e.g., a predetermined luminance) in response to a voltage of the data signal.

Additionally, in FIG. 1, each of the pixels PX is connected to four scan lines SL1, SL2, SL3, and SL4, but the present disclosure is not limited thereto. For example, the number of scan lines SL1, SL2, SL3, and SL4 connected to each of the pixels PX may be variously set in correspondence with a circuit structure of the pixels PX.

The scan driver 130 may receive a scan driving signal SCS from the timing controller 120. The scan driving signal SCS may include a scan start signal and the like necessary for driving the scan driver 130. In addition, the scan driver 130 may receive selection clock signals sCK1: sCK11, sCK12, . . . , sCK1n, sCK2: sCK21, sCK22, . . . , and sCK2n from the clock controller 170. The scan driver 130 may generate an enable first scan signal, an enable second scan signal, an enable third scan signal, and an enable fourth scan signal while shifting the scan start signal in response to the selection clock signals sCK1 and sCK2.

The enable first scan signal, the enable second scan signal, the enable third scan signal, and the enable fourth scan signal may mean that a gate-on voltage is supplied to the scan lines SL1, SL2, SL3, and SL4. That is, a fact that the enable first scan signal is supplied to the first scan line SL1 may mean that a gate-on voltage at which a transistor connected to the first scan line SL1 may be turned on is supplied to the first scan line SL1. For example, a low level of enable scan signal may be supplied to a P-type transistor, and a high level of enable scan signal may be supplied to an N-type transistor.

During a period in which an enable scan signal is not supplied to the scan lines SL1, SL2, SL3, and SL4, a disable scan signal may be supplied to each of the scan lines SL1, SL2, SL3, and SL4. A disable first scan signal, a disable second scan signal, a disable third scan signal, and a disable fourth scan signal may mean that a gate-off voltage is supplied to the scan lines SL1, SL2, SL3, and SL4. That is, a fact that the disable first scan signal is supplied to the first scan line SL1 may mean that a gate-off voltage at which a transistor connected to the first scan line SL1 may be turned off is supplied to the first scan line SL1. For example, a high level of disable scan signal may be supplied to a P-type transistor, and a low level of disable scan signal may be supplied to an N-type transistor.

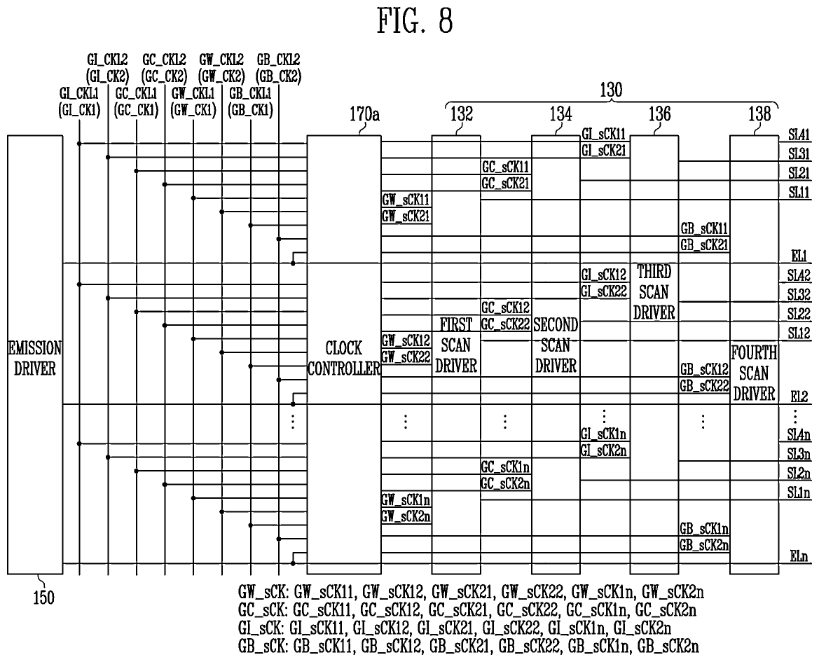

The scan driver 130 may include a plurality of scan drivers, for example, a first scan driver 132, a second scan driver 134, a third scan driver 136, and a fourth scan driver 138 as shown in FIG. 8. At least two of the first scan driver 132, the second scan driver 134, the third scan driver 136, and the fourth scan driver 138 may be formed as one driver, and each may be formed as a separate driver.

In one or more embodiments, the scan driver 130 may be disposed in the display device 100 as a separate integrated circuit (IC). In one or more embodiments, the scan driver 130 may be formed together with the pixels PX in a formation process of the pixel unit 110. For example, the scan driver 130 may be formed in the pixel unit 110 as an oxide semiconductor thin film transistor gate driver circuit (OSG) type or an amorphous silicon thin film transistor gate driver circuit (ASG) type.

The data driver 140 may receive output data Dout and a data driving signal DCS from the timing controller 120. The data driving signal DCS may include a sampling signal and/or timing signals necessary for driving the data driver 140. The data driver 140 may generate a data signal based on the data driving signal DCS and the output data Dout. For example, the data driver 140 may generate an analog data signal based on a grayscale of the output data Dout. The data driver 140 may supply the data signal to the data lines DL1 to DLm to be synchronized with the enable first scan signal.

The emission driver 150 may receive an emission driving signal ECS from the timing controller 120. The emission driving signal ECS may include an emission start signal and clock signals necessary for driving the emission driver 150. The emission driver 150 may generate a disable emission control signal while shifting the emission start signal in response to the clock signal.

The disable emission control signal may mean that a gate-off voltage is supplied to an emission control line EL. That is, supply of the disable emission control signal may mean that a gate-off voltage at which a transistor connected to the emission control line EL may be turned off is supplied to the emission control line EL. For example, a high level of disable emission control signal may be supplied to a P-type transistor, and a low level of disable emission control signal may be supplied to an N-type transistor. Additionally, supply of the disable emission control signal to the emission control line EL may be expressed as supply of the emission control signal to the emission control line EL.

During a period in which the disable emission control signal is not supplied to the emission control line EL, the enable emission control signal may be supplied to the emission control line EL. The enable emission control signal may mean that a gate-on voltage is supplied to the emission control line EL. That is, supply of the enable emission control signal may mean that a gate-on voltage at which a transistor connected to the emission control line EL may be turned on is supplied to the emission control line EL. For example, a low level of enable emission control signal may be supplied to a P-type transistor, and a high level of enable emission control signal may be supplied to an N-type transistor. In one or more embodiments, supply of the enable emission control signal to the emission control line EL may be expressed as stop of supply of the emission control signal to the emission control line EL. In one or more embodiments, supply of the disable emission control signal to the emission control line EL may be referred to as supply of the emission control signal to the emission control line EL.

The timing controller 120 may receive input data Din and a control signal CS from a host system through an interface. For example, the timing controller 120 may receive the input data Din and the control signal CS from at least one of a graphics processing unit (GPU), a central processing unit (CPU), and an application processor (AP) included in the host system. The control signal CS may include various signals including a clock signal.

The timing controller 120 may generate the scan driving signal SCS, the data driving signal DCS, and the emission driving signal ECS based on the control signal CS. The scan driving signal SCS, the data driving signal DCS, and the emission driving signal ECS may be supplied to the scan driver 130, the data driver 140, and the emission driver 150, respectively.

The timing controller 120 may rearrange the input data Din to match a specification of the display device 100. In addition, the timing controller 120 may correct the input data Din to generate the output data Dout and supply the output data Dout to the data driver 140. In one or more embodiments, the timing controller 120 may correct the input data Din in response to an optical measurement result measured in a process.

Additionally, the timing controller 120 may supply clock signals CK1 and CK2 necessary for driving the scan driver 130 to the clock controller 170. In FIG. 1, two clock signals CK1 and CK2 are supplied to the clock controller 170, but the present disclosure is not limited thereto. For example, the timing controller 120 may supply at least one clock signal to the clock controller 170 in correspondence with a stage circuit included in the scan driver 130.

The clock controller 170 may receive the disable emission control signal from the emission driver 150 and receive the clock signals CK1 and CK2 from the timing controller 120. Additionally, the clock controller 170 may sequentially output the clock signals CK1 and CK2 in the horizontal line unit. Here, the clock signals CK1 and CK2 output in the horizontal line unit may be referred to as selection clock signals sCK1 and sCK2.

In one or more embodiments, the clock controller 170 may output the selection clock signals sCK11 and sCK21 corresponding to the first horizontal line during a period in which the disable emission control signal is supplied to the first emission control line EL1. Then, the scan driver 130 may respectively output the enable first scan signal, the enable second scan signal, the enable third scan signal, and the enable fourth scan signal to the scan lines SL11, SL21, SL31, and SL41 positioned on the first horizontal line in response to the selection clock signals sCK11 and sCK21.

In one or more embodiments, the clock controller 170 may output the selection clock signals sCK12 and sCK22 corresponding to the second horizontal line during a period in which the disable emission control signal is supplied to the second emission control line EL2. Then, the scan driver 130 may respectively output the enable first scan signal, the enable second scan signal, the enable third scan signal, and the enable fourth scan signal to the scan lines SL12, SL22, SL32, and SL42 positioned on the second horizontal line in response to the selection clock signals sCK12 and sCK22.

In one or more embodiments, the clock controller 170 may output the selection clock signals sCK1n and sCK2n corresponding to the n-th horizontal line during a period in which the disable emission control signal is supplied to the n-th emission control line ELn. Then, the scan driver 130 may respectively output the enable first scan signal, the enable second scan signal, the enable third scan signal, and the enable fourth scan signal to the scan lines SL1n, SL2n, SL3n, and SL4n positioned on the n-th horizontal line in response to the selection clock signals sCK1n and sCK2n.

In one or more embodiments of the present disclosure, the clock signals CK1 and CK2 may be selectively supplied using the clock controller 170. In this case, a stage circuit included in the scan driver 130 and positioned for each horizontal line receives the selection clock signals sCK1 and sCK2 only during a period in which the enable scan signal is generated, and does not receive the selection clock signals sCK1 and sCK2 during other periods. That is, in one or more embodiments of the present disclosure, the clock controller 170 may selectively supply the clock signals CK1 and CK2, and thus power consumption may be reduced.

The power supply 160 may generate various power required for driving the display device 100. For example, the power supply 150 may generate first driving power VDD, second driving power VSS, first initialization power Vint1, and second initialization power Vint2.

The first driving power VDD may be power supplying a driving current to the pixels PX. The second driving power VSS may be power receiving the driving current from the pixels PX. During a period in which the pixels PX are set to an emission state, the first driving power VDD may be set to a voltage higher than that of the second driving power VSS.

First initialization power Vint1 may be a voltage that initializes a gate electrode of a driving transistor (a first transistor M21 shown in FIG. 6) included in each of the pixels PX. The first initialization power Vint1 may be set to a voltage value lower than the data signal. The second initialization power Vint2 may be a voltage that initializes a first electrode (or an anode electrode) of a light emitting element LD (refer to FIG. 6) included in each of the pixels PX. Second initialization power Vint2 may have a voltage value at which the light emitting element LD is turned off when the second initialization power Vint2 is supplied to the first electrode of the light emitting element LD.

For example, as shown in FIG. 6, the first driving power VDD generated by the power supply 160 may be supplied to a first power line PL1, the second driving power VSS may be supplied to a second power line PL2, the first initialization power Vint1 may be supplied to a third power line PL3, and the second initialization power Vint2 may be supplied to a fourth power line PL4. The first power line PL1, the second power line PL2, the third power line PL3, and the fourth power line PL4 may be commonly connected to the pixels PX, but the present disclosure is not limited thereto.

In one or more embodiments, the first power line PL1 may be configured of a plurality of power lines, and the plurality of power lines may be connected to different pixels PX. In one or more embodiments, the second power line PL2 may be configured of a plurality of power lines, and the plurality of power lines may be connected to different pixels PX. In one or more embodiments, the third power line PL3 may be configured of a plurality of power lines, and the plurality of power lines may be connected to different pixels PX. In one or more embodiments, the fourth power line PL4 may be configured of a plurality of power lines, and the plurality of power lines may be connected to different pixels PX. That is, in one or more embodiments of the present disclosure, the pixels PX may be connected to any one of the first power lines PL1, any one of the second power lines PL2, any one of the third power lines PL3, and any one of the fourth power lines PL4.

In one or more embodiments of the present disclosure, the display device 100 may include a flat display device, a curved display device in which a portion of the pixel unit 110 is bent, a flexible display device in which a portion may be folded and/or bent, and a stretchable display device in which a portion may be expanded and contracted.

In one or more embodiments of the present disclosure, the display device 100 may be a device that displays a moving image and/or a still image, and may include a portable electronic device such as a mobile phone, a smart phone, a tablet personal computer (PC), a smart watch, a watch phone, a mobile communication terminal, an electronic notebook, an e-book, a portable multimedia player (PMP), a navigation system, and an ultra-mobile PC (UMPC). In one or more embodiments of the present disclosure, the display device 100 may include an electronic device such as a television, a notebook computer, a monitor, a billboard, or Internet of things (IoT).

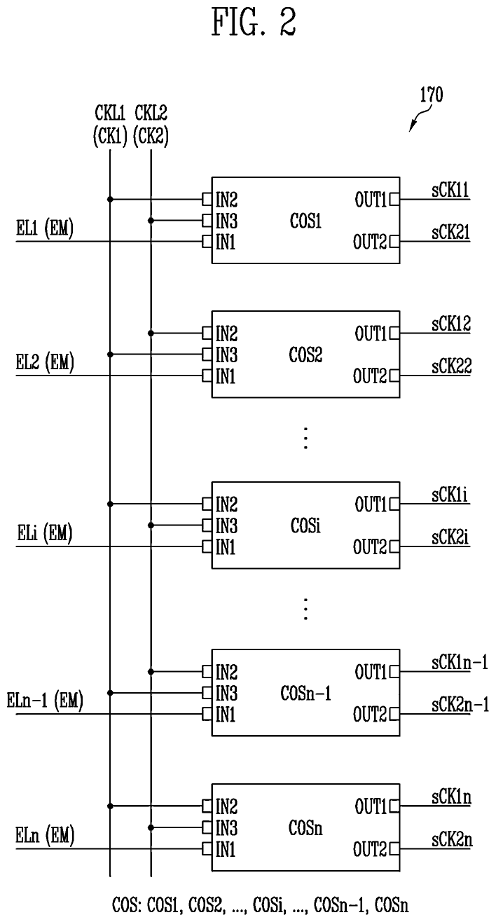

FIG. 2 is a diagram illustrating an embodiment of the clock controller shown in FIG. 1.

Referring to FIG. 2, the clock controller 170 according to one or more embodiments of the present disclosure may include a plurality of clock selection circuits COS1, COS2, . . . , COSi, . . . , COSn−1, and COSn. A clock selection circuit COS may be connected to a first clock line CKL1 and a second clock line CKL2. For example, a second input terminal IN2 of each of the odd-numbered clock selection circuits COS1, . . . , COSi, . . . , and COSn may be connected to the first clock line CKL1 to which the first clock signal CK1 is supplied, and a third input terminal IN3 may be connected to the second clock line CKL2 to which the second clock signal CK2 is supplied. In addition, a second input terminal IN2 of each of the even-numbered clock selection circuits COS2, . . . , and COSn−1 may be connected to the second clock line CKL2 to which the second clock signal CK2 is supplied, and the third input terminal IN3 may be connected to the first clock line CKL1 to which the first clock signal CK1 is supplied.

The clock selection circuit COS may be positioned for each horizontal line, and each clock selection circuit COS may be connected to the emission control line EL corresponding to a horizontal line on which each clock selection circuit COS is positioned. For example, a first input terminal IN1 of the first clock selection circuit COS1 positioned on the first horizontal line may be connected to the first emission control line EL1, and a first input terminal IN1 of the n-th clock selection circuit COSn positioned on the n-th horizontal line may be connected to the n-th emission control line ELn.

In one or more embodiments, the first clock selection circuit COS1 may output the clock signals CK1 and CK2 during a period in which the disable emission control signal is supplied to the first emission control line EL1. Here, the clock signals CK1 and CK2 output from the first clock selection circuit COS1 may be the selection clock signals sCK11 and sCK21. For example, when the disable emission control signal is supplied to the first emission control line EL1, the first clock selection circuit COS1 may output the first selection clock signal sCK11 (or the first clock signal CK1) to a first output terminal OUT1, and output the second selection clock signal sCK21 (or the second clock signal CK2) to a second output terminal OUT2.

The second clock selection circuit COS2 may output the clock signals CK1 and CK2 during a period in which the disable emission control signal is supplied to the second emission control line EL2. Here, the clock signals CK1 and CK2 output from the second clock selection circuit COS2 may be the selection clock signals sCK12 and sCK22. For example, when the disable emission control signal is supplied to the second emission control line EL2, the second clock selection circuit COS2 may output the second selection clock signal sCK12 (or the second clock signal CK2) to the first output terminal OUT1, and output the second selection clock signal sCK22 (or the first clock signal CK1) to the second output terminal OUT2.

Similarly, the i-th clock selection circuit COSi may output the selection clock signals sCK1i and sCK2i during a period in which the disable emission control signal is supplied to the i-th emission control line ELi, the (n−1)-th clock selection circuit COSn−1 may output the selection clock signals sCK1n−1 and sCK2n−1 during a period in which the disable emission control signal is supplied to the (n−1)-th emission control line ELn−1, and the n-th clock selection circuit COSn may output the selection clock signals sCK1n and sCK2n during a period in which the disable emission control signal is supplied to the n-th emission control line ELn.

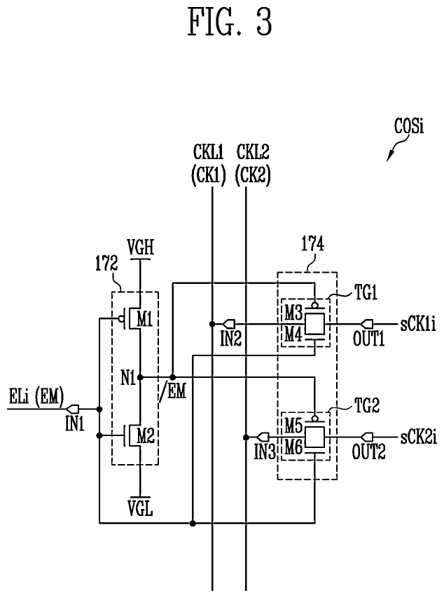

FIG. 3 is a circuit diagram illustrating an embodiment of the clock selection circuit shown in FIG. 2. FIG. 3 shows the i-th clock selection circuit COSi, and the remaining clock selection circuits may have substantially the same circuit configuration as the i-th clock selection circuit COSi.

Referring to FIG. 3, the clock selection circuit COSi according to one or more embodiments of the present disclosure may include an inverter 172 and a controller 174.

The inverter 172 is connected to the first input terminal IN1. The first input terminal IN1 is connected to the i-th emission control line ELi, and receives the disable emission control signal EM (the emission control signal, or an input signal) from the i-th emission control line ELi. The inverter 172 may invert the disable emission control signal EM to generate an enable emission control signal /EM (an inverted emission control signal, or an inverted input signal). Here, the disable emission control signal EM may have a high level voltage, and the enable emission control signal /EM may have a low level voltage.

In one or more embodiments, the inverter 172 may include a first transistor M1 and a second transistor M2 connected in series between a first power source VGH and a second power source VGL. The first power source VGH may be set to a high level voltage, and the second power source VGL may be set to a low level voltage lower than that of the first power source VGH.

The first transistor M1 may be connected between the first power source VGH and a first node N1 (or an output node), and a gate electrode may be connected to the first input terminal IN1. The first transistor M1 may be turned off when the disable emission control signal EM (a high level voltage) is supplied, and may be turned on when a low-level voltage signal is supplied to the gate electrode. To this end, the first transistor M1 may be set as a P-type transistor.

The second transistor M2 may be connected between the first node N1 and the second power source VGL, and a gate electrode may be connected to the first input terminal IN1. The second transistor M2 may be turned on when the disable emission control signal EM (a high level voltage) is supplied, and may be turned off when a low-level voltage signal is supplied to the gate electrode. To this end, the second transistor M2 may be set as an N-type transistor.

When the disable emission control signal EM is supplied to the first input terminal IN1, the controller 174 may electrically connect the second input terminal IN2 to the first output terminal OUT1 and electrically connect the third input terminal IN3 to the second input terminal OUT2. To this end, the controller 174 may include a first transmission gate TG1 and a second transmission gate TG2.

The first transmission gate TG1 may be connected between the second input terminal IN2 and the first output terminal OUT1. The first transmission gate TG1 controls an electrical connection of the second input terminal IN2 and the first output terminal OUT1 in response to the disable emission control signal EM and the enable emission control signal /EM. To this end, the first transmission gate TG1 may include a third transistor M3 and a fourth transistor M4.

The third transistor M3 may be connected between the second input terminal IN2 and the first output terminal OUT1, and a gate electrode may be connected to the first node N1. The third transistor M3 may be turned on when the enable emission control signal /EM is supplied to the first node N1 to electrically connect the second input terminal IN2 and the first output terminal OUT1. To this end, the third transistor M3 may be set as a P-type transistor.

The fourth transistor M4 may be connected between the second input terminal IN2 and the first output terminal OUT1, and a gate electrode may be connected to the first input terminal IN1. The fourth transistor M4 may be turned on when the disable emission control signal EM is supplied to the first input terminal IN1 to electrically connect the second input terminal IN2 and the first output terminal OUT1. To this end, the fourth transistor M4 may be set as an N-type transistor.

The second transmission gate TG2 may be connected between the third input terminal IN3 and the second output terminal OUT2. The second transmission gate TG2 controls an electrical connection of the third input terminal IN3 and the second output terminal OUT2 in response to the disable emission control signal EM and the enable emission control signal /EM. To this end, the second transmission gate TG2 may include a fifth transistor M5 and a sixth transistor M6.

The fifth transistor M5 may be connected between the third input terminal IN3 and the second output terminal OUT2, and a gate electrode may be connected to the first node N1. The fifth transistor M5 may be turned on when the enable emission control signal /EM is supplied to the first node N1 to electrically connect the third input terminal IN3 and the second output terminal OUT2. To this end, the fifth transistor M5 may be set as a P-type transistor.

The sixth transistor M6 may be connected between the third input terminal IN3 and the second output terminal OUT2, and a gate electrode may be connected to the first input terminal IN1. The sixth transistor M6 may be turned on when the disable emission control signal EM is supplied to the first input terminal IN1 to electrically connect the third input terminal IN3 and the second output terminal OUT2. To this end, the sixth transistor M6 may be set as an N-type transistor.

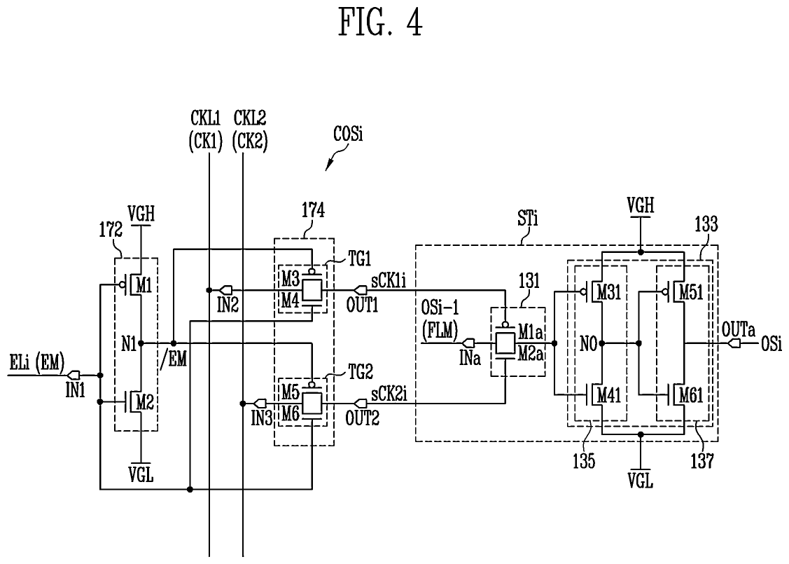

FIG. 4 is a diagram illustrating an embodiment of the clock selection circuit and the stage circuit. FIG. 4 shows the i-th stage circuit STi connected to the i-th clock selection circuit COSi. The stage circuit STi may be included in the scan driver 130 and may be formed for each horizontal line.

Referring to FIG. 4, the stage circuit STi may receive a previous stage output signal OSi−1 (or a start signal FLM) through an input terminal INa, and output an output signal OSi through an output terminal OUTa. The stage circuit STi may include an input unit 131 and an output unit 133.

The input unit 131 may be connected to the first output terminal OUT1 and the second output terminal OUT2 of the clock selection circuit COSi. The input unit 131 may supply the previous stage output signal OSi−1, which is input to the input terminal INa when the first selection clock signal sCK1i is output to the first output terminal OUT1 and the second selection clock signal sCK2i is output to the second output terminal OUT2, to the output unit 133.

To this end, the input unit 131 may include a first input transistor M1a and a second input transistor M2a connected to a transmission gate. The first input transistor M1a and the second input transistor M2a may be connected in parallel between the input terminal INa and the output unit 133.

The first input transistor M1a may be set as a P-type transistor and may be turned on or off in response to the first selection clock signal sCK1i supplied from the first output terminal OUT1. The second input transistor M2a may be set as an N-type transistor and may be turned on or off in response to the second selection clock signal sCK2i supplied from the second output terminal OUT2.

The output unit 133 may output the output signal OSi to the output terminal OUTa in response to the previous stage output signal OSi−1 supplied from the input unit 131. Here, the output signal OSi may be supplied to the scan line as the enable scan signal. For example, the output signal OSi may be supplied to the scan line (at least one of SL1i, SL2i, SL3i, and SL4i) as the enable first scan signal, the enable second scan signal, the enable third scan signal, and/or the enable fourth scan signal.

The output unit 133 may include a first inverter 135 and a second inverter 137. The first inverter 135 may generate an inverted output signal by inverting the previous stage output signal OSi−1. The second inverter 137 may generate the output signal OSi by inverting the inverted output signal from the first inverter 135.

The first inverter 135 may include a third transistor M31 and a fourth transistor M41 connected in series between the first power source VGH and the second power source VGL. The third transistor M31 may be connected between the first power source VGH and an output node NO, and a gate electrode may be connected to the input unit 131. The fourth transistor M41 may be connected between the output node NO and the second power source VGL, and a gate electrode may be connected to the input unit 131. The third transistor M31 may be set as a P-type transistor, and the fourth transistor M41 may be set as an N-type transistor.

The second inverter 137 may include a fifth transistor M51 and a sixth transistor M61 connected in series between the first power source VGH and the second power source VGL. The fifth transistor M51 may be connected between the first power source VGH and the output terminal OUTa, and a gate electrode may be connected to the output node NO. The sixth transistor M61 may be connected between the output terminal OUTa and the second power source VGL, and a gate electrode may be connected to the output node NO. The fifth transistor M51 may be set as a P-type transistor, and the sixth transistor M61 may be set as an N-type transistor.

Additionally, in one or more embodiments of the present disclosure, the stage circuit STi may include various currently known configurations. For example, the stage circuit STi may include the input unit 131 having a transmission gate that receives the previous stage output signal OSi−1 (or the start signal FLM) through the input terminal INa, and other configurations may include various currently known configurations.

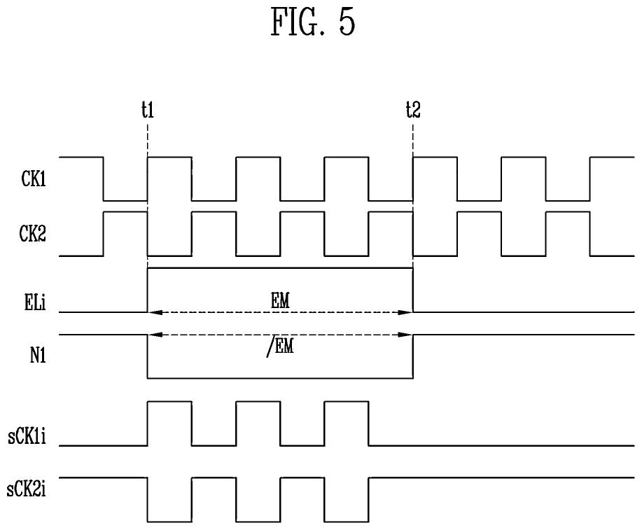

FIG. 5 is a waveform diagram illustrating one or more embodiments of a method of driving the clock selection circuit.

Referring to FIGS. 2-5, the first clock signal CK1 may be input to the first clock line CKL1, and the second clock signal CK2 may be input to the second clock line CKL2. Here, the first clock signal CK1 and the second clock signal CK2 may be signals with the same period and inverted phases.

At a first time point t1, the disable emission control signal EM is supplied to the i-th emission control line ELi. The disable emission control signal EM may be supplied to the first input terminal IN1 of the i-th clock selection circuit COSi through the i-th emission control line ELi. Then, the second transistor M2 included in the i-th clock selection circuit COSi is turned on. When the second transistor M2 is turned on, a voltage of the second power source VGL may be supplied to the first node N1.

Here, the voltage of the second power source VGL supplied to the first node N1 may be supplied to the third transistor M3 and the fifth transistor M5 as the enable emission control signal /EM, and thus the third transistor M3 and the fifth transistor M5 may be turned on. In addition, the disable emission control signal EM to be supplied to the i-th emission control line ELi may be supplied to the fourth transistor M4 and the sixth transistor M6, and thus the fourth transistor M4 and the sixth transistor M6 may be turned on.

When the third transistor M3 and the fourth transistor M4 are turned on, the first clock line CKL1 and the first output terminal OUT1 are electrically connected, and thus the first clock signal CK1, that is, the first selection clock signal sCK1i may be output to the first output terminal OUT1.

When the fifth transistor M5 and the sixth transistor M6 are turned on, the second clock line CKL2 and the second output terminal OUT2 may be electrically connected, and thus the second clock signal CK2, that is, the second selection clock signal sCK2i may be output to the second output terminal OUT2. That is, the i-th clock selection circuit COSi may output the selection clock signals sCK1i and sCK2i during a period in which the disable emission control signal EM is supplied to the i-th emission control line ELi.

When the selection clock signals sCK1i and sCK2i are output from the i-th clock selection circuit COSi, the output signal OSi may be generated in the i-th stage circuit STi in response to the previous stage output signal OSi−1. The output signal OSi may be supplied to the scan line as the enable scan signal.

At a second time point t2, supply of the disable emission control signal EM to the i-th emission control line ELi may be stopped. Then, the first transistor M1 may be turned on, and thus a voltage of the first power source VGH may be supplied to the first node N1. In this case, the third to sixth transistors M3 to M6 may be set to a turn-off state, and thus supply of the selection clock signals sCK1i and sCK2i may be stopped.

That is, in one or more embodiments of the present disclosure, the selection clock signals sCK1i and sCK2i may be supplied only during a period in which the output signal OSi is generated in the stage circuit STi, and supply of the selection clock signals sCK1i and sCK2i may be stopped during other periods. When supply of the selection clock signals sCK1i and sCK2i is stopped, the input transistors M1a and M2a included in the input unit of the stage circuit STi may be prevented from being turned on and off periodically, and thus power consumption may be reduced.

FIG. 6 is a diagram illustrating an embodiment of the pixel shown in FIG. 1. FIG. 6 shows a pixel positioned on the i-th horizontal line and a j-th vertical line.

Referring to FIG. 6, the pixel PXij according to one or more embodiments of the present disclosure may be connected to corresponding signal lines SL1i, SL2i, SL3i, SL4i, ELi, and DLj. For example, the pixel PXij may be connected to the i-th first scan line SL1i, the i-th second scan line SL2i, the i-th third scan line SL3i, the i-th fourth scan line SL4i, the i-th emission control line ELi, and the j-th data line DLj. In one or more embodiments, the pixel PXij may be further connected to the first power line PL1, the second power line PL2, the third power line PL3, and the fourth power line PL4.

The i-th third scan line SL3i may be an (i−1)-th second scan line SL2i−1. The i-th fourth scan line SL4i may be an (i−1)-th first scan line SL1i−1. In this case, a signal necessary for driving the actual pixel PXij may be a first scan signal GW, a second scan signal GC, and an emission control signal EM. That is, the i-th third scan line SL3i may be driven by a second scan signal of a previous pixel row, and the i-th fourth scan line SL4i may be driven by a first scan signal of the previous pixel row.

The pixel PXij according to one or more embodiments of the present disclosure may include the light emitting element LD and a pixel circuit for controlling a current amount supplied to the light emitting element LD.

The light emitting element LD may be connected between the first power line PL1 and the second power line PL2. For example, a first electrode (or an anode electrode) of the light emitting element LD may be electrically connected to the first power line PL1 via a sixth transistor M26, a third node N23, a first transistor M21, a second node N22, and a fifth transistor M25, and a second electrode (or a cathode electrode) of the light emitting element LD may be electrically connected to the second power line PL2. The light emitting element LD may generate light of a desired luminance (e.g., a predetermined luminance) in response to the current amount supplied from the first power line PL1 to the second power line PL2 via the pixel circuit.

The light emitting element LD may be selected as an organic light emitting diode (OLED). In addition, the light emitting element LD may be selected as an inorganic light emitting diode (LED) such as a micro LED or a quantum dot LED. In addition, the light emitting element LD may be an element configured of a combination of an organic material and an inorganic material. Although FIG. 6 shows that the pixel PXij includes a single light emitting element LD, in one or more embodiments, the pixel PXij may include a plurality of light emitting elements LD and the plurality of light emitting elements LD may be connected in series, parallel, or in a series-parallel combination to each other.

The pixel circuit may include the first transistor M21 (e.g., a driving transistor), a second transistor M22 (e.g., a switching transistor), a third transistor M23, a fourth transistor M24, the fifth transistor M25, the sixth transistor M26, a seventh transistor M27, and a storage capacitor Cst.

A first electrode of the first transistor M21 (or a driving transistor) may be connected to the second node N22, and a second electrode may be connected to the third node N23. In addition, a gate electrode of the first transistor M21 may be connected to a first node N21. The first transistor M21 may control the current amount supplied from the first driving power VDD to the second driving power VSS via the light emitting element LD in response to a voltage of the first node N21.

The second transistor M22 may be connected between the data line DLj and the second node N22. In addition, a gate electrode of the second transistor M22 may be electrically connected to the first scan line SL1i. The second transistor M22 may be turned on when the enable first scan signal GW is supplied to the first scan line SL1i to electrically connect the data line DLj and the second node N22.

A first electrode of the third transistor M23 may be connected to the first node N21, and a second electrode may be electrically connected to the third power line PL3. In addition, a gate electrode of the third transistor M23 may be electrically connected to the third scan line SL3i. The third transistor M23 may be turned on when an enable third scan signal GI is supplied to the third scan line SL3i to supply a voltage of the first initialization power Vint1 to the first node N21. The first initialization power Vint1 may be set to a voltage lower than that of the data signal supplied to the data line DLj.

The fourth transistor M24 may be connected between the first node N21 and the third node N23. In addition, a gate electrode of the fourth transistor M24 may be electrically connected to the second scan line SL2i. The fourth transistor M24 may be turned on when the enable second scan signal GC is supplied to the second scan line SL2i to electrically connect the first node N21 and the third node N23. That is, when the fourth transistor M24 is turned on, the first transistor M21 may be connected as a diode (e.g., the first transistor M21 may be diode-connected).

A first electrode of the fifth transistor M25 may be electrically connected to the first power line PL1, and a second electrode may be connected to the second node N22. In addition, a gate electrode of the fifth transistor M25 may be electrically connected to the emission control line ELi. The fifth transistor M25 may be turned off when the disable emission control signal EM is supplied to the emission control line ELi, and turned on when the emission control signal EM is not supplied (or the enable emission control signal is supplied).

The sixth transistor M26 may be connected between the third node N23 and the first electrode of the light emitting element LD. In addition, a gate electrode of the sixth transistor M26 may be electrically connected to the emission control line ELi. The sixth transistor M26 may be turned off when the disable emission control signal EM is supplied to the emission control line ELi, and turned on when the emission control signal EM is not supplied.

A first electrode of the seventh transistor M27 may be connected to the first electrode of the light emitting element LD, and a second electrode may be electrically connected to the fourth power line PL4. In addition, a gate electrode of the seventh transistor M27 may be electrically connected to the fourth scan line SL4i. The seventh transistor M27 may be turned on when an enable fourth scan signal GB is supplied to the fourth scan line SL4i to supply a voltage of the second initialization power Vint2 to the first electrode of the light emitting element LD.

When the voltage of the second initialization power Vint2 is supplied to the

first electrode of the light emitting element LD, a parasitic capacitor of the light emitting element LD may be discharged. As a residual voltage charged in the parasitic capacitor of the light emitting element LD is discharged (or removed), unintended fine light emission may be prevented. Accordingly, black expression capability of the pixel PXij may be improved.

The storage capacitor Cst may be connected between the first power line PL1 and the first node N21. The storage capacitor Cst may store the voltage applied to the first node N21.

In one or more embodiments, the first transistor M21, the second transistor M22, the fifth transistor M25, the sixth transistor M26, and the seventh transistor M27 may be formed of a polysilicon semiconductor transistor. For example, the first transistor M21, the second transistor M22, the fifth transistor M25, the sixth transistor M26, and the seventh transistor M27 may include a polysilicon semiconductor layer formed through a low temperature poly-silicon (LTPS) process as an active layer (e.g., a transistor channel). In addition, the first transistor M21, the second transistor M22, the fifth transistor M25, the sixth transistor M26, and the seventh transistor M27 may be P-type transistors (for example, PMOS transistors). Accordingly, a gate-on voltage for turning on the first transistor M21, the second transistor M22, the fifth transistor M25, the sixth transistor M26, and the seventh transistor M27 may be a low level. Because the polysilicon semiconductor transistor has an advantage of fast response speed, the polysilicon semiconductor transistor may be applied to a switching element requiring fast switching.

In one or more embodiments, the third transistor M23 and the fourth transistor M24 may be formed of an oxide semiconductor transistor. For example, the third transistor M23 and the fourth transistor M24 may be N-type oxide semiconductor transistors (for example, NMOS transistors) and may include an oxide semiconductor layer as an active layer (e.g., a transistor channel). Accordingly, a gate-on voltage for turning on the third transistor M23 and the fourth transistor M24 may be a high level.

The oxide semiconductor transistor may be processed at a low temperature and has charge mobility lower than that of the polysilicon semiconductor transistor. That is, the oxide semiconductor transistor has an excellent off current characteristic. Therefore, when the third transistor M23 and the fourth transistor M24 are formed of the oxide semiconductor transistors, a leakage current due to low-frequency driving may be reduced or minimized, and thus display quality may be improved.

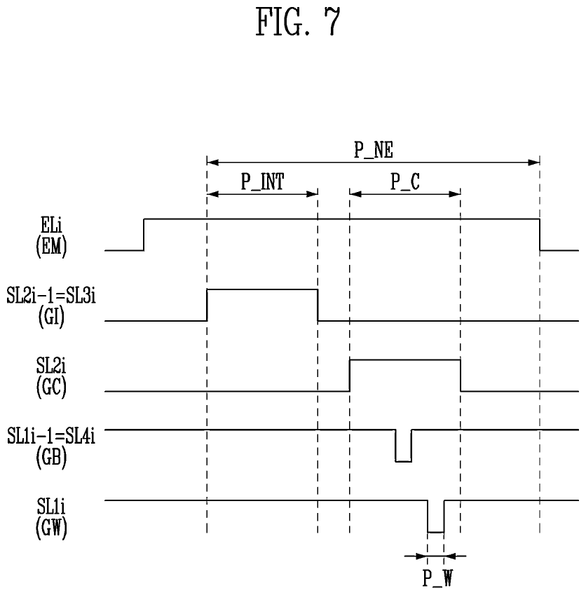

FIG. 7 is a waveform diagram illustrating an embodiment of a method of driving the pixel shown in FIG. 6.

Referring to FIG. 7, one frame period may include a non-emission period P_NE, and the non-emission period P_NE may include an initialization period P_INT, a compensation period P_C, and a writing period P_W. The writing period P_W may be included in the compensation period P_C.

In the non-emission period P_NE, the disable emission control signal EM (that is, a high level voltage) may be supplied. In this case, the fifth transistor M25 and the sixth transistor M26 may be turned off in response to the disable emission control signal EM, and the pixel PXij may not emit light.

In the initialization period P_INT, the third scan signal GI may have a high level (that is, the enable third scan signal). In this case, the third transistor M23 may be turned on in response to the enable third scan signal GI, and the voltage of the first initialization power Vint1 of the third power line PL3 may be provided to the first node N21.

Thereafter, during the compensation period P_C, the second scan signal GC may have a high level (that is, the enable second scan signal). The fourth transistor M24 may be turned on in response to the enable second scan signal GC, and the first transistor M21 may be connected as a diode (e.g., the first transistor M21 may be diode-connected).

In the writing period P_W, the first scan signal GW may have a low level (that is, the enable first scan signal). In this case, the second transistor M22 may be turned on in response to the enable first scan signal GW, and the data signal may be provided to the second node N22 from the j-th data line DLj. In addition, because the fourth transistor M24 is turned on in response to the enable second scan signal GC, the data signal may be transferred from the second node N22 to the first node N21 via the first transistor M21 and the fourth transistor M24. Because the first transistor M21 maintains a diode-connected form by the turned on fourth transistor M24, the first node N21 may have a voltage in which a threshold voltage of the first transistor M21 is compensated for in the data signal.

Before the writing period P_W, the fourth scan signal GB may have a low level (that is, the enable fourth scan signal). In this case, the seventh transistor M27 may be turned on in response to the enable fourth scan signal GB, and the voltage of the second initialization power Vint2 may be supplied to the first electrode of the light emitting element LD.

Thereafter, the non-emission period P_NE may be ended, and the emission control signal EM may have a low level (that is, the enable emission control signal). In this case, the fifth transistor M25 and the sixth transistor M26 are turned on in response to the low level of emission control signal EM. When the fifth transistor M25 and the sixth transistor M26 are turned on, a current movement path 1 is formed to the second power line PL2 through the first power line PL1, the fifth transistor M25, the first transistor M21, the sixth transistor M26, and the light emitting element LD. At this time, according to an operation of the first transistor M21, a driving current corresponding to the voltage of the first node N21 may flow through the light emitting element LD, and the light emitting element LD may emit light with a luminance corresponding to the driving current.

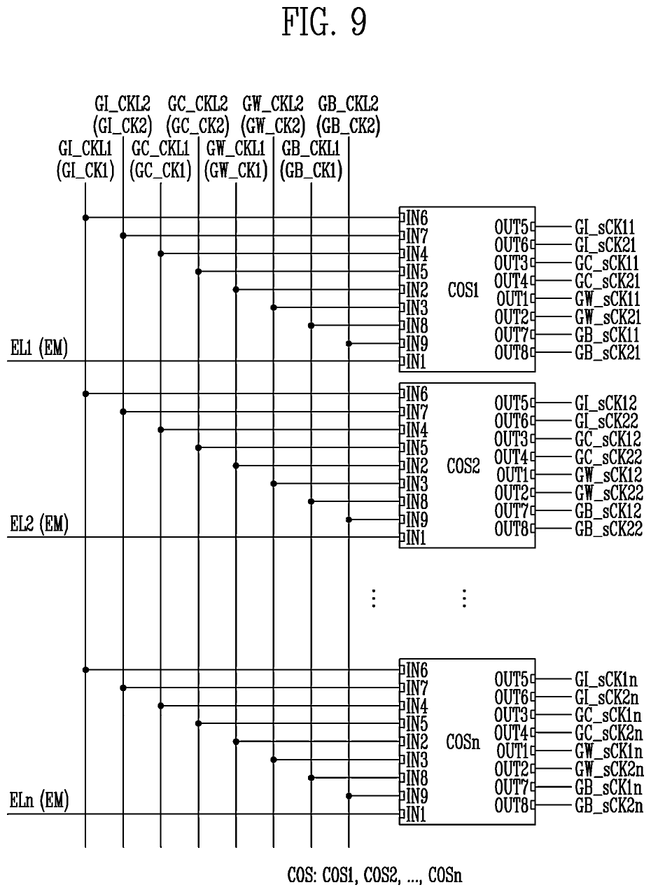

FIG. 8 is a diagram illustrating an embodiment of the scan driver shown in FIG. 1. FIG. 9 is a diagram illustrating an embodiment of a clock controller shown in FIG. 8.

Referring to FIGS. 8 and 9, the scan driver 130 may include a first scan driver 132 for sequentially outputting the enable first scan signal GW, a second scan driver 134 for sequentially outputting the enable second scan signal GC, a third scan driver 136 for sequentially outputting the enable third scan signal GI, and a fourth scan driver 138 for sequentially outputting the enable fourth scan signal GB. In one or more embodiments, the third scan driver 136 may be replaced with the second scan driver 134, and the fourth scan driver 138 may be replaced with the first scan driver 132.

The first scan driver 132, the second scan driver 134, the third scan driver 136, and the fourth scan driver 138 may be driven in response to different clock signals. In this case, the clock controller 170a may supply different selection clock signals GW_sCK, GC_sCK, GI_sCK, and GB_sCK to the respective first scan driver 132, second scan driver 134, third scan driver 136, and fourth scan driver 138.

The timing controller 120 may supply clock signals GW_CK1 and GW_CK2 (or writing clock signals) necessary for driving the first scan driver 132 to the clock controller 170a by using clock lines GW_CKL1 and GW_CKL2. A second input terminal IN2 included in each clock selection circuit COS may be connected to the clock line GW_CKL1, and a third input terminal IN3 may be connected to the clock line GW_CKL2.

The timing controller 120 may supply clock signals GC_CK1 and GC_CK2 (or compensation clock signals) necessary for driving the second scan driver 134 to the clock controller 170a by using the clock lines GC_CKL1 and GC_CKL2. A fourth input terminal IN4 included in each clock selection circuit COS may be connected to the clock line GC_CKL1, and a fifth input terminal IN5 may be connected to the clock line GC_CKL2.

The timing controller 120 may supply clock signals GI_CK1 and GI_CK2 necessary for driving the third scan driver 136 to the clock controller 170a by using the clock lines GI_CKL1 and GI_CKL2. A sixth input terminal IN6 included in each clock selection circuit COS may be connected to the clock line GI_CKL1, and a seventh input terminal IN7 may be connected to the clock line GI_CKL2.

The timing controller 120 may supply clock signals GB_CK1 and GB_CK2 necessary for driving the fourth scan driver 138 to the clock controller 170a by using the clock lines GB_CKL1, GB_CKL2. An eighth input terminal IN8 included in each clock selection circuit COS may be connected to the clock line GB_CKL1, and a ninth input terminal IN9 may be connected to the clock line GB_CKL2.

The clock controller 170a may receive the disable emission control signal from the emission driver 150, and receive the clock signals GW_CK1, GW_CK2, GC_CK1, GC_CK2, GI_CK1, GI_CK2, GB_CK1, and GB_CK2 from the timing controller 120. The clock controller 170a may sequentially output the selection clock signals GW_sCK, GC_sCK, GI_sCK, and GB_sCK in a horizontal line unit in response to the disable emission control signal supplied in the horizontal line unit.

In one or more embodiments, the clock controller 170a may output selection clock signals GW_sCK11, GW_sCK21, GC_sCK11, GC_sCK21, GI_sCK11, GI_sCK21, GB_sCK11, and GB_sCK21 corresponding to the first horizontal line during a period in which the disable emission control signal is supplied to the first emission control line EL1. For example, the selection clock signal GW_sCK11 may be output to a first output terminal OUT1 of the first clock selection circuit COS1, the selection clock signal GW_sCK21 may be output to a second output terminal OUT2, the selection clock signal GC_sCK11 may be output to a third output terminal OUT3, the selection clock signal GC_sCK21 may be output to a fourth output terminal OUT4, the selection clock signal GI_sCK11 may be output to a fifth output terminal OUT5, the selection clock signal GI_sCK21 may be output to a sixth output terminal OUT6, the selection clock signal GB_sCK11 may be output to a seventh output terminal OUT7, and the selection clock signal GB_sCK21 may be output to an eighth output terminal OUT8.

Here, the selection clock signals GW_sCK11 and GW_sCK21 may be supplied to the first scan driver 132, the selection clock signals GC_sCK11 and GC_sCK21 may be supplied to the second scan driver 134, the selection clock signals GI_sCK11 and GI_sCK21 may be supplied to the third scan driver 136, and the selection clock signals GB_sCK11 and GB_sCK21 may be supplied to the fourth scan driver 138.

The first scan driver 132 receiving the selection clock signals GW_sCK11 and GW_sCK21 may supply the enable first scan signal GW to the first scan line SL11. The second scan driver 134 receiving the selection clock signals GC_sCK11 and GC_sCK21 may supply the enable second scan signal GC to the second scan line SL21. The third scan driver 136 receiving the selection clock signals GI_sCK11 and GI_sCK21 may supply the enable third scan signal GI to the third scan line SL31. The fourth scan driver 138 receiving the selection clock signals GB_sCK11 and GB_sCK21 may supply the enable fourth scan signal GB to the fourth scan line SL41.

In one or more embodiments, the clock controller 170a may output selection clock signals GW_sCK12, GW_sCK22, GC_sCK12, GC_sCK22, GI_sCK12, GI_sCK22, GB_sCK12, and GB_sCK22 corresponding to the second horizontal line during a period in which the disable emission control signal is supplied to the second emission control line EL2. For example, the selection clock signal GW_sCK12 may be output to the first output terminal OUT1 of the second clock selection circuit COS2, the selection clock signal GW_sCK22 may be output to the second output terminal OUT2, the selection clock signal GC_sCK12 may be output to the third output terminal OUT3, the selection clock signal GC_sCK22 may be output to the fourth output terminal OUT4, the selection clock signal GI_sCK12 may be output to the fifth output terminal OUT5, the selection clock signal GI_sCK22 may be output to the sixth output terminal OUT6, the selection clock signal GB_sCK12 may be output to the seventh output terminal OUT7, and the selection clock signal GB_sCK22 may be output to the eighth output terminal OUT8.

Here, the selection clock signals GW_sCK12 and GW_sCK22 may be output to the first scan driver 132, the selection clock signals GC_sCK12 and GC_sCK22 may be supplied to the second scan driver 134, the selection clock signals GI_sCK12 and GI_sCK22 may be supplied to the third scan driver 136, and the selection clock signals GB_sCK12 and GB_sCK22 may be supplied to the fourth scan driver 138.

The first scan driver 132 receiving the selection clock signals GW_sCK12 and GW_sCK22 may supply the enable first scan signal GW to the first scan line SL12. The second scan driver 134 receiving the selection clock signals GC_sCK12 and GC_sCK22 may supply the enable second scan signal GC to the second scan line SL22. The third scan driver 136 receiving the selection clock signals GI_sCK12 and GI_sCK22 may supply the enable third scan signal GI to the third scan line SL32. The fourth scan driver 138 receiving the selection clock signals GB_sCK12 and GB_sCK22 may supply the enable fourth scan signal GB to the fourth scan line SL42.

In one or more embodiments, the clock controller 170a may output selection clock signals GW_sCK1n, GW_sCK2n, GC_sCK1n, GC_sCK2n, GI_sCK1n, GI_sCK2n, GB_sCK1n, and GB_sCK2n corresponding to the n-th horizontal line during a period in which the disable emission control signal is supplied to the n-th emission control line ELn. For example, the selection clock signal GW_sCK1n may be output to the first output terminal OUT1 of the n-th clock selection circuit COSn, the selection clock signal GW_sCK2n may be output to the second output terminal OUT2, the selection clock signal GC_sCK1n may be output to the third output terminal OUT3, the selection clock signal GC_sCK2n may be output to the fourth output terminal OUT4, the selection clock signal GI_sCK1n may be output to the fifth output terminal OUT5, the selection clock signal GI_sCK2n may be output to the sixth output terminal OUT6, the selection clock signal GB_sCK1n may be output to the seventh output terminal OUT7, and the selection clock signal GB_sCK2n may be output to the eighth output terminal OUT8.

Here, the selection clock signals GW_sCK1n and GW_sCK2n may be supplied to the first scan driver 132, the selection clock signals GC_sCK1n and GC_sCK2n may be supplied to the second scan driver 134, the selection clock signals GI_sCK1n and GI_sCK2n may be supplied to the third scan driver 136, and the selection clock signals GB_sCKIn and GB_sCK2n may be supplied to the fourth scan driver 138.

The first scan driver 132 receiving the selection clock signals GW_sCK1n and GW_sCK2n may supply the enable first scan signal GW to the first scan line SL1n. The second scan driver 134 receiving the selection clock signals GC_sCK1n and GC_sCK2n may supply the enable second scan signal GC to the second scan line SL2n. The third scan driver 136 receiving the selection clock signals GI_sCK1n and GI_sCK2n may supply the enable third scan signal GI to the third scan line SL3n. The fourth scan driver 138 receiving the selection clock signals GB_sCK1n and GB_sCK2n may supply the enable fourth scan signal GB to the fourth scan line SL4n.

The clock selection circuit COS may be positioned for each horizontal line, and each clock selection circuit COS may be connected to the emission control line EL corresponding to the horizontal line on which each clock selection circuit COS is positioned. For example, the first input terminal IN1 of the first clock selection circuit COS1 positioned on the first horizontal line may be connected to the first emission control line EL1, and the first input terminal IN1 of the n-th clock selection circuit COSn positioned on the n-th horizontal line may be connected to the n-th emission control line ELn.

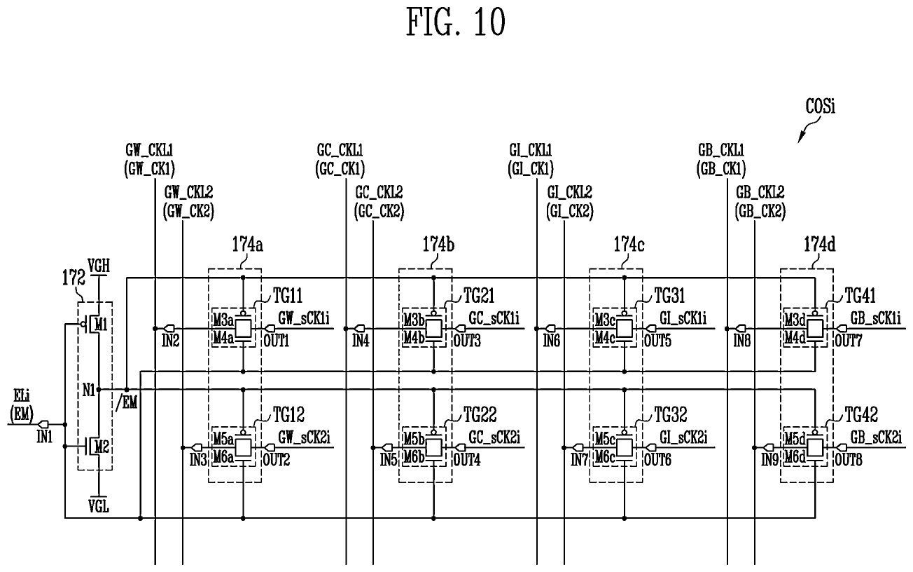

FIG. 10 is a diagram illustrating an embodiment of the clock selection circuit shown in FIG. 9. FIG. 10 shows the i-th clock selection circuit COSi. When describing FIG. 10, a configuration identical or similar to that of FIG. 3 is briefly described.

Referring to FIG. 10, the clock selection circuit COSi according to one or more embodiments of the present disclosure may include an inverter 172 and controllers 174a, 174b, 174c, and 174d.

The inverter 172 is connected to the first input terminal IN1. The first input terminal IN1 is connected to the i-th emission control line ELi and receives the disable emission control signal EM from the i-th emission control line ELi. The inverter 172 may generate the enable emission control signal /EM by inverting the disable emission control signal EM. Here, the disable emission control signal EM may have a high level voltage, and the enable emission control signal /EM may have a low level voltage.

The inverter 172 may include a first transistor M1 and a second transistor M2 connected in series between the first power source VGH and the second power source VGL. The first power source VGH may be set to a high level voltage, and the second power source VGL may be set to a low level voltage lower than that of the first power source VGH.

The first transistor M1 may be connected between the first power source VGH and a first node N1, and a gate electrode may be connected to the first input terminal IN1. The first transistor M1 may be turned off when the disable emission control signal EM is supplied, and may be turned on when a low-level voltage signal is supplied to the gate electrode. To this end, the first transistor M1 may be set as a P-type transistor.

The second transistor M2 may be connected between the first node N1 and the second power source VGL, and a gate electrode may be connected to the first input terminal IN1. The second transistor M2 may be turned on when the disable emission control signal EM is supplied, and may be turned off when a low-level voltage signal is supplied to the gate electrode. To this end, the second transistor M2 may be set as an N-type transistor.

When the disable emission control signal EM is supplied to the first input terminal IN1, the first controller 174a may electrically connect the second input terminal IN2 to the first output terminal OUT1 and electrically connect the third input terminal IN3 to the second input terminal OUT2. To this end, the first controller 174a may include a first transmission gate TG11 and a second transmission gate TG12.

The first transmission gate TG11 may be connected between the second input terminal IN2 and the first output terminal OUT1. The first transmission gate TG11 controls an electrical connection of the second input terminal IN2 and the first output terminal OUT1 in response to the disable emission control signal EM and the enable emission control signal /EM. To this end, the first transmission gate TG11 may include a third transistor M3a and a fourth transistor M4a.

The third transistor M3a may be connected between the second input terminal IN2 and the first output terminal OUT1, and a gate electrode may be connected to the first node N1. The third transistor M3a may be turned on when the enable emission control signal /EM is supplied to the first node N1 to electrically connect the second input terminal IN2 and the first output terminal OUT1. To this end, the third transistor M3a may be set as a P-type transistor.

The fourth transistor M4a may be connected between the second input terminal IN2 and the first output terminal OUT1, and a gate electrode may be connected to the first input terminal IN1. The fourth transistor M4a may be turned on when the disable emission control signal EM is supplied to the first input terminal IN1 to electrically connect the second input terminal IN2 and the first output terminal OUT1. To this end, the fourth transistor M4a may be set as an N-type transistor.

The second transmission gate TG12 may be connected between the third input terminal IN3 and the second output terminal OUT2. The second transmission gate TG12 controls an electrical connection of the third input terminal IN3 and the second output terminal OUT2 in response to the disable emission control signal EM and the enable emission control signal /EM. To this end, the second transmission gate TG12 may include a fifth transistor M5a and a sixth transistor M6a.

The fifth transistor M5a may be connected between the third input terminal IN3 and the second output terminal OUT2, and a gate electrode may be connected to the first node N1. The fifth transistor M5a may be turned on when the enable emission control signal /EM is supplied to the first node N1 to electrically connect the third input terminal IN3 and the second output terminal OUT2. To this end, the fifth transistor M5a may be set as a P-type transistor.

The sixth transistor M6a may be connected between the third input terminal IN3 and the second output terminal OUT2, and a gate electrode may be connected to the first input terminal IN1. The sixth transistor M6a may be turned on when the disable emission control signal EM is supplied to the first input terminal IN1 to electrically connect the third input terminal IN3 and the second output terminal OUT2. To this end, the sixth transistor M6a may be set as an N-type transistor.

When the disable emission control signal EM is supplied to the first input terminal IN1, the second controller 174b may electrically connect the fourth input terminal IN4 to the third output terminal OUT3 and electrically connect the fifth input terminal IN5 to the fourth output terminal OUT4. To this end, the second controller 174b may include a first transmission gate TG21 and a second transmission gate TG22.

The first transmission gate TG21 may be connected between the fourth input terminal IN4 and the third output terminal OUT3. When the disable emission control signal EM is input to the first input terminal IN1 and the enable emission control signal /EM is input to the first node N1, the first transmission gate TG21 may electrically connect the fourth input terminal IN4 and the third output terminal OUT3. To this end, the first transmission gate TG21 may include a P-type third transistor M3b of which a gate electrode is connected to the first node N1, and an N-type fourth transistor M4b of which a gate electrode is connected to the first input terminal IN1.

The second transmission gate TG22 may be connected between the fifth input terminal IN5 and the fourth output terminal OUT4. When the disable emission control signal EM is input to the first input terminal IN1 and the enable emission control signal /EM is input to the first node N1, the second transmission gate TG22 may electrically connect the fifth input terminal IN5 and the fourth output terminal OUT4. To this end, the second transmission gate TG22 may include a P-type fifth transistor M5b of which a gate electrode is connected to the first node N1, and an N-type sixth transistor M6b of which a gate electrode is connected to the first input terminal IN1.

When the disable emission control signal EM is supplied to the first input terminal IN1, the third controller 174c may electrically connect the sixth input terminal IN6 to the fifth output terminal OUT5 and electrically connect the seventh input terminal IN7 to the sixth output terminal OUT6. To this end, the third controller 174c may include a first transmission gate TG31 and a second transmission gate TG32.

The first transmission gate TG31 may be connected between the sixth input terminal IN6 and the fifth output terminal OUT5. When the disable emission control signal EM is input to the first input terminal IN1 and the enable emission control signal /EM is input to the first node N1, the first transmission gate TG31 may electrically connect the sixth input terminal IN6 and the fifth output terminal OUT5. To this end, the first transmission gate TG31 may include a P-type third transistor M3c of which a gate electrode is connected to the first node N1, and an N-type fourth transistor M4c of which a gate electrode is connected to the first input terminal IN1.

The second transmission gate TG32 may be connected between the seventh input terminal IN7 and the sixth output terminal OUT6. When the disable emission control signal EM is input to the first input terminal IN1 and the enable emission control signal /EM is input to the first node N1, the second transmission gate TG32 may electrically connect the seventh input terminal IN7 and the sixth output terminal OUT6. To this end, the second transmission gate TG32 may include a P-type fifth transistor M5c of which a gate electrode is connected to the first node N1 and an N-type sixth transistor M6c of which a gate electrode is connected to the first input terminal IN1.

When the disable emission control signal EM is supplied to the first input terminal IN1, the fourth controller 174d may electrically connect the eighth input terminal IN8 to the seventh output terminal OUT7 and electrically connect the ninth input terminal IN9 to the eighth output terminal OUT8. To this end, the fourth controller 174d may include a first transmission gate TG41 and a second transmission gate TG42.

The first transmission gate TG41 may be connected between the eighth input terminal IN8 and the seventh output terminal OUT7. When the disable emission control signal EM is input to the first input terminal IN1 and the enable emission control signal /EM is input to the first node N1, the first transmission gate TG41 may electrically connect the eighth input terminal IN8 and the seventh output terminal OUT7. To this end, the first transmission gate TG41 may include a P-type third transistor M3d of which a gate electrode is connected to the first node N1, and an N-type fourth transistor M4d of which a gate electrode is connected to the first input terminal IN1.

The second transmission gate TG42 may be connected between the ninth input terminal IN9 and the eighth output terminal OUT8. When the disable emission control signal EM is input to the first input terminal IN1 and the enable emission control signal /EM is input to the first node, the second transmission gate TG42 may electrically connect the ninth input terminal IN9 and the eighth output terminal OUT8. To this end, the second transmission gate TG42 may include a P-type fifth transistor M5d of which a gate electrode is connected to the first node N1, and an N-type sixth transistor M6d of which a gate electrode is connected to the first input terminal IN1.

When describing an operation process, when the disable emission control signal EM is supplied to the i-th emission control line ELi, the enable emission control signal /EM may be supplied to the first node N1 by the inverter 172.

Then, the transistors M3a to M3d, M4a to M4d, M5a to M5d, and M6a to M6d included in each of the controllers 174a to 174d may be turned on, and thus the selection clock signals GW_sCK1i, GW_sCK2i, GC_sCK1i, GC_sCK2i, GI_sCK1i, GI_sCK2i, GB_sCK1i, and GB_sCK2i may be output.

As shown in FIG. 7, the disable emission control signal EM is supplied to overlap the enable scan signals GW, GC, GI, and GB. Therefore, when the selection clock signals GW_sCK1i, GW_sCK2i, GC_sCK1i, GC_sCK2i, GI_sCK1i, GI_sCK2i, GB_sCK1i, and GB_sCK2i are output during a period in which the disable emission control signal EM is supplied, the scan signals GW, GC, GI, and GB may be stably generated.

Although FIG. 10 shows four controllers 174a to 174d, the present disclosure is not limited thereto. The clock selection circuit COS may include the inverter 172 and one or more controllers. The number of controllers included in the clock selection circuit COS may be set variously to correspond to the number of scan drivers.

In addition, in FIGS. 3 and 10, the inverter 172 included in the clock selection circuit COS receives the disable emission control signal EM, but the present disclosure is not limited thereto. For example, the inverter 172 may have the widest width from among signals (for example, the scan signal, the emission control signal, and the like) supplied in the horizontal line unit, and may receive a signal overlapping other signals.

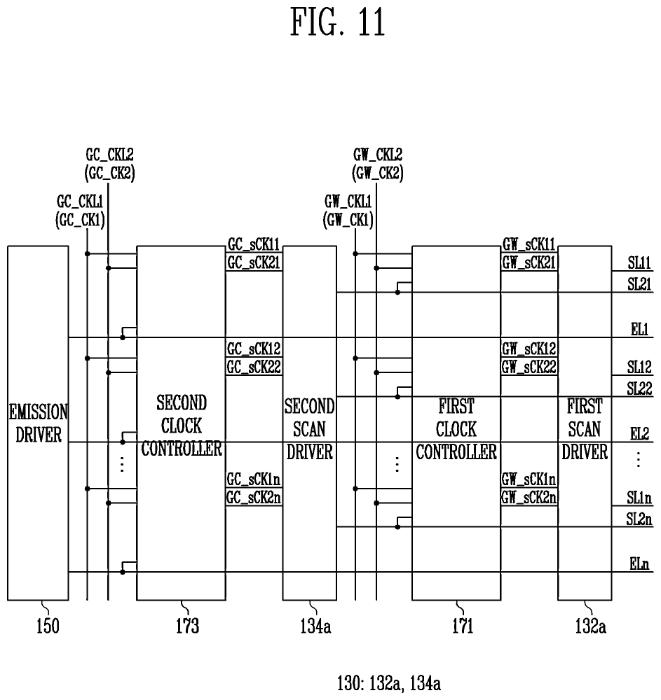

FIG. 11 is a diagram illustrating an embodiment of the scan driver and the clock controller of FIG. 1.

Referring to FIG. 11, the scan driver 130 may include a first scan driver 132a for sequentially outputting the enable first scan signal GW and a second scan driver 134a for sequentially outputting the enable second scan signal GC. In this case, the third scan line SL3 shown in FIG. 1 may be driven by the second scan driver 134a, and the fourth scan line SL4 may be driven by the first scan driver 132a.

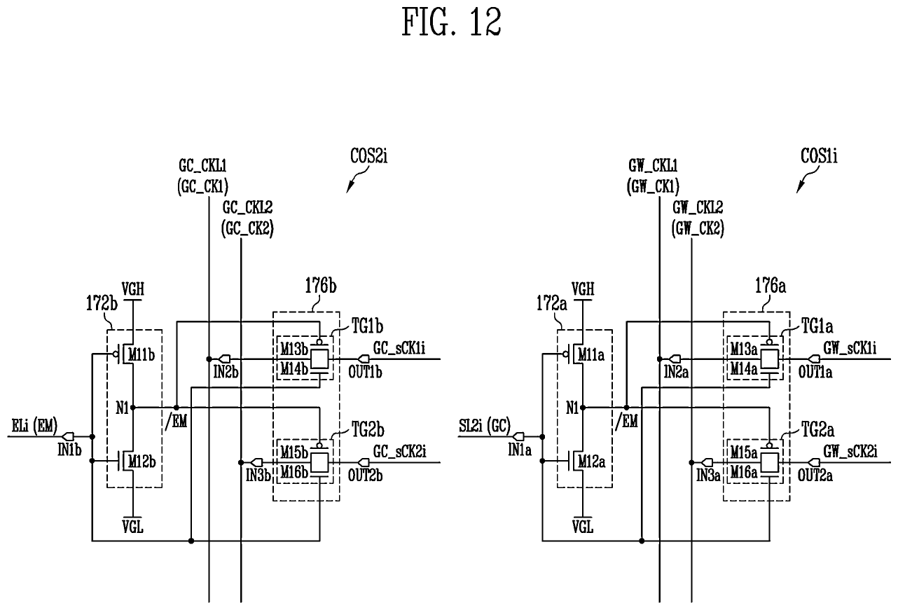

The timing controller 120 may supply the clock signals GW_CK1 and GW_CK2 necessary for driving the first scan driver 132a to a first clock controller 171 by using the clock lines GW_CKL1 and GW_CKL2. The first clock controller 171 may include a first clock selection circuit positioned for each horizontal line, a second input terminal IN2a (refer to FIG. 12) included in each first clock selection circuit may be connected to the clock line GW_CKL1, and a third input terminal IN3a (refer to FIG. 12) may be connected to the clock line GW_CKL2.

The timing controller 120 may supply the clock signals GC_CK1 and GC_CK2 necessary for driving the second scan driver 134a to a second clock controller 173 by using the clock lines GC_CKL1 and GC_CKL2. The second clock controller 173 may include a second clock selection circuit positioned for each horizontal line, a second input terminal IN2b (refer to FIG. 12) included in each second clock selection circuit may be connected to the clock line GC_CKL1, and a third input terminal IN3b (refer to FIG. 12) may be connected to the clock line GC_CKL2.

The first clock controller 171 may receive the enable second scan signal GC from the second scan driver 134a and receive the clock signals GW_CK1 and GW_CK2 from the timing controller 120. The first clock controller 171 may sequentially output the clock signals GW_CK1 and GW_CK2 in the horizontal line unit in response to the enable second scan signal GC supplied in the horizontal line unit.

In one or more embodiments, the first clock controller 171 may output the selection clock signals GW_sCK11 and GW_sCK21 corresponding to the first horizontal line during a period in which the enable second scan signal GC is supplied to the second scan line SL21. The first scan driver 132a receiving the selection clock signals GW_sCK11 and GW_sCK21 may supply the enable first scan signal GW to the first scan line SL11.

In one or more embodiments, the first clock controller 171 may output the selection clock signals GW_sCK12 and GW_sCK22 corresponding to the second horizontal line during a period in which the enable second scan signal GC is supplied to the second scan line SL22. The first scan driver 132a receiving the selection clock signals GW_sCK12 and GW_sCK22 may supply the enable first scan signal GW to the first scan line SL12.

In one or more embodiments, the first clock controller 171 may output the selection clock signals GW_sCK1n and GW_sCK2n corresponding to the n-th horizontal line during a period in which the enable second scan signal GC is supplied to the second scan line SL2n. The first scan driver 132a receiving the selection clock signals GW_sCK1n and GW_sCK2n may supply the enable first scan signal GW to the first scan line SL1n.

As shown in FIG. 7, the second scan signal GC supplied to the i-th second scan line SL2i is supplied to overlap the first scan signal GW supplied to the i-th first scan line SL1i. Therefore, even though the second scan signal GC is supplied to the first clock controller 171, the first scan signal GW may be stably generated in the horizontal line unit.

The second clock controller 173 may receive the disable emission control signal EM from the emission driver 150 and receive the clock signals GC_CK1 and GC_CK2 from the timing controller 120. The second clock controller 173 may sequentially output the clock signals GC_CK1 and GC_CK2 in the horizontal line unit in response to the disable emission control signal EM supplied in the horizontal line unit.

In one or more embodiments, the second clock controller 173 may output the selection clock signals GC_sCK11 and GC_sCK21 corresponding to the first horizontal line during a period in which the disable emission control signal EM is supplied to the emission control line EL1. The second scan driver 134a receiving the selection clock signals GC_sCK11 and GC_sCK21 may supply the enable second scan signal GC to the second scan line SL21.

In one or more embodiments, the second clock controller 173 may output the selection clock signals GC_sCK12 and GC_sCK22 corresponding to the second horizontal line during a period in which the disable emission control signal EM is supplied to the emission control line EL2. The second scan driver 134a receiving the selection clock signals GC_sCK12 and GC_sCK22 may supply the enable second scan signal GC to the second scan line SL22.

In one or more embodiments, the second clock controller 173 may output the selection clock signals GC_sCK1n and GC_sCK2n corresponding to the n-th horizontal line during a period in which the disable emission control signal EM is supplied to the emission control line ELn. The second scan driver 134a receiving the selection clock signals GC_sCK1n and GC_sCK2n may supply the enable second scan signal GC to the second scan line SL2n.

FIG. 12 is a circuit diagram illustrating an embodiment of the clock selection circuit included in each of the first clock controller and the second clock controller of FIG. 11. FIG. 12 shows an i-th first clock selection circuit COS1i and an i-th second clock selection circuit COS2i. When describing FIG. 12, a configuration similar to that of FIG. 3 is briefly described.

Referring to FIG. 12, the first clock selection circuit COS1i may include an inverter 172a and a controller 176a.

The inverter 172a is connected to the first input terminal IN1a. The first input terminal IN1a may be connected to the i-th second scan line SL2i, and may receive the enable second scan signal GC from the i-th second scan line SL2i. The inverter 172a may include a P-type first transistor M11a and an N-type second transistor M12a connected in series between the first power source VGH and the second power source VGL.

When the enable second scan signal GC is input to the first input terminal IN1a, the controller 176a may electrically connect the second input terminal IN2a to a first output terminal OUT1a and electrically connect the third input terminal IN3a to a second output terminal OUT2a. To this end, the controller 176a may include a first transmission gate TG1a and a second transmission gate TG2a.

The first transmission gate TG1a may be connected between the second input terminal IN2a and the first output terminal OUT1a. When the enable second scan signal GC is input to the first input terminal IN1a, the first transmission gate TG1a may electrically connect the second input terminal IN2a and the first output terminal OUT1a. To this end, the first transmission gate TG1a may include a P-type third transistor M13a and an N-type fourth transistor M14a.

The second transmission gate TG2a may be connected between the third input terminal IN3a and the second output terminal OUT2a. When the enable second scan signal GC is input to the first input terminal IN1a, the second transmission gate TG2a may electrically connect the third input terminal IN3a and the second output terminal OUT2a. To this end, the second transmission gate TG2a may include a P-type fifth transistor M15a and an N-type sixth transistor M16a.

The first clock selection circuit COS1i may output the selection clock signals GW_sCK1i and GW_sCK2i when the enable second scan signal GC is input, and an operation process thereof may be similar or identical to that of the selection clock circuit of FIG. 3.

The second clock selection circuit COS2i may include an inverter 172b and a controller 176b.

The inverter 172b is connected to a first input terminal IN1b. The first input terminal IN1b may be connected to the i-th emission control line ELi, and may receive the disable emission control signal EM from the i-th emission control line ELi. The inverter 172b may include a P-type first transistor M11b and an N-type second transistor M12b connected in series between the first power source VGH and the second power source VGL.

When the disable emission control signal EM is input to the first input

terminal IN1b, the controller 176b may electrically connect the second input terminal IN2b to a first output terminal OUT1b and electrically connect the third input terminal IN3b to a second output terminal OUT2b. To this end, the controller 176b may include a first transmission gate TG1b and a second transmission gate TG2b.

The first transmission gate TG1b may be connected between the second input terminal IN2b and the first output terminal OUT1b. When the disable emission control signal EM is input to the first input terminal IN1b, the first transmission gate TG1b may electrically connect the second input terminal IN2b and the first output terminal OUT1b. To this end, the first transmission gate TG1b may include a P-type third transistor M13b and an N-type fourth transistor M14b.

The second transmission gate TG2b may be connected between the third input terminal IN3b and the second output terminal OUT2b. When the disable emission control signal EM is input to the first input terminal IN1b, the second transmission gate TG2b may electrically connect the third input terminal IN3b and the second output terminal OUT2b. To this end, the second transmission gate TG2b may include a P-type fifth transistor M15b and an N-type sixth transistor M16b.

The second clock selection circuit COS2i may output the selection clock signals GC_sCK1i and GC_sCK2i when the disable emission control signal EM is input, and an operation process thereof may be similar or identical to that of the selection clock circuit of FIG. 3.

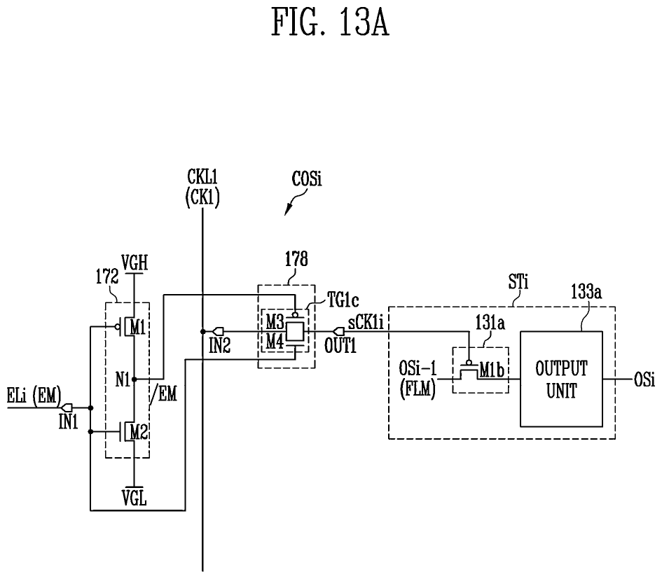

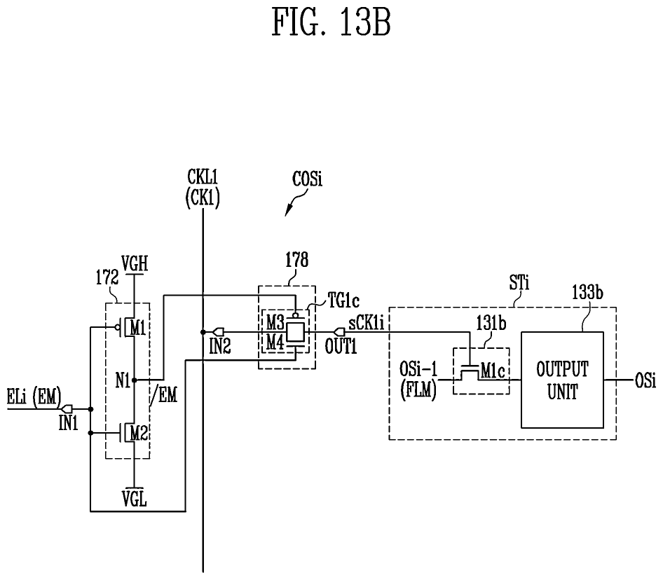

FIGS. 13A and 13B are diagrams illustrating an embodiment of the clock selection circuit and the stage circuit, as discussed with respect to the display device of FIG. 1. FIGS. 13A and 13B illustrate a case where only a P-type transistor or an N-type transistor is included in the input unit of the stage circuit STi. When describing FIGS. 13A and 13B, the same reference numerals are assigned to the same configurations as those of FIG. 3 (or FIG. 4) and a detailed description is omitted.

Referring to FIGS. 13A and 13B, the clock selection circuit COSi includes an inverter 172 and a controller 178.

When the disable emission control signal EM is supplied to the first input terminal IN1, the controller 178 may electrically connect the second input terminal IN2 and the first output terminal OUT1. The second input terminal IN2 may be connected to the clock line CKL1, and may receive the clock signal CK1 from the clock line CKL1.

The controller 178 may include a transmission gate TG1c connected between the second input terminal IN2 and the first output terminal OUT1. The transmission gate TG1c may include a P-type third transistor M3 and an N-type fourth transistor M4.

A gate electrode of the third transistor M3 may be connected to the first node N1, and the third transistor M3 may be turned on when the enable emission control signal /EM is supplied to the first node N1. A gate electrode of the fourth transistor M4 may be connected to the first input terminal IN1, and the fourth transistor M4 may be turned on when the disable emission control signal EM is supplied to the first input terminal IN1. That is, when the disable emission control signal EM is supplied to the first input terminal IN1, the clock selection circuit COSi may supply the selection clock signal sCK1i to the first output terminal OUT1.

Input units 131a and 131b of the stage circuit STi may include one transistor M1b or M1c. For example, the input unit 131a may include the P-type first input transistor M1b. For example, the input unit 131b may include the N-type first input transistor M1c.

The input units 131a and 131b may supply the previous stage output signal OSi−1 to output units 133a and 133b when the selection clock signal sCK1i is supplied. A configuration of the output units 133a and 133b may be configured of various currently known circuits.

Although the above has been described with reference to the embodiments of the present disclosure, those skilled in the art will understand that the present disclosure may be variously modified and changed without departing from the spirit and scope of the present disclosure described in the claims.

What is claimed is:

1. A clock selection circuit comprising:
an inverter configured to receive an input signal through a first input terminal; and
at least one controller configured to receive at least one clock signal and configured to output the clock signal when the input signal is supplied to the inverter.

2. The clock selection circuit according to claim 1, wherein the inverter comprises a P-type first transistor and an N-type second transistor connected in series between a first power source and a second power source having a voltage lower than that of the first power source, and
a gate electrode of the first transistor and a gate electrode of the second transistor are connected to the first input terminal.

3. The clock selection circuit according to claim 2, wherein the controller comprises a first transmission gate connected between a first output terminal and a second input terminal connected to a first clock line configured to receive a first clock signal,
wherein the first transmission gate comprises a P-type third transistor and an N-type fourth transistor connected in parallel between the second input terminal and the first output terminal, and
wherein a gate electrode of the third transistor is connected to a first node which is a common node of the first transistor and the second transistor, and a gate electrode of the fourth transistor is connected to the first input terminal.

4. The clock selection circuit according to claim 3, wherein when the input signal is input to the first input terminal, the third transistor and the fourth transistor are turned on, and when the input signal is not supplied, the third transistor and the fourth transistor are turned off.

5. The clock selection circuit according to claim 3, wherein the controller further comprises a second transmission gate connected between a second output terminal and a third input terminal connected to a second clock line configured to receive a second clock signal,
wherein the second transmission gate comprises a P-type fifth transistor and an N-type sixth transistor connected in parallel between the third input terminal and the second output terminal, and
wherein a gate electrode of the fifth transistor is connected to the first node, and a gate electrode of the sixth transistor is connected to the first input terminal.

6. The clock selection circuit according to claim 5, wherein when the input signal is input to the first input terminal, the fifth transistor and the sixth transistor are turned on, and when the input signal is not supplied, the fifth transistor and the sixth transistor are turned off.

7. A display device comprising:
pixels connected to scan lines, emission control lines, and data lines;
a scan driver configured to supply a scan signal to the scan lines;
an emission driver configured to supply an emission control signal to the emission control lines; and
a clock controller configured to receive at least one clock signal to drive the scan driver, and configured to determine whether to supply the clock signal to the scan driver in response to the emission control signal.

8. The display device according to claim 7, wherein the clock controller is configured to sequentially receive the emission control signal in a horizontal line unit, and configured to output the clock signal in the horizontal line unit in response to the emission control signal.

9. The display device according to claim 8, wherein the clock controller comprises a plurality of clock selection circuits, the scan driver comprises a plurality of stage circuits, and
wherein an i-th (i is a natural number) clock selection circuit at an i-th horizontal line is configured to supply the clock signal to an i-th stage circuit at the i-th horizontal line when the emission control signal is supplied to i-th emission control line.

10. The display device according to claim 9, wherein the i-th clock selection circuit does not supply the clock signal to the i-th stage circuit when the emission control signal is not supplied to the i-th emission control line.

11. The display device according to claim 9, wherein the i-th clock selection circuit comprises:
a first input terminal connected to the i-th emission control line;
an inverter connected to the first input terminal; and
a controller connected to the first input terminal and a first node which is an output node of the inverter, and configured to supply the clock signal to the i-th stage circuit when the emission control signal is supplied to the first input terminal.

12. The display device according to claim 11, wherein the inverter comprises a P-type first transistor and an N-type second transistor connected in series between a first power source and a second power source having a voltage lower than that of the first power source, and
wherein a gate electrode of the first transistor and a gate electrode of the second transistor are connected to the first input terminal.

13. The display device according to claim 11, wherein the controller comprises a first transmission gate connected between a first output terminal and a second input terminal connected to a first clock line configured to receive a first clock signal,
wherein the first transmission gate comprises a P-type third transistor and an N-type fourth transistor connected in parallel between the second input terminal and the first output terminal, and
wherein a gate electrode of the third transistor is connected to the first node, and a gate electrode of the fourth transistor is connected to the first input terminal.

14. The display device according to claim 13, wherein the first clock signal is supplied to the i-th stage circuit via the first output terminal when the first transmission gate is turned on.

15. The display device according to claim 13, wherein the controller further comprises a second transmission gate connected between a second output terminal and a third input terminal connected to a second clock line configured to receive a second clock signal,
wherein the second transmission gate comprises a P-type fifth transistor and an N-type sixth transistor connected in parallel between the third input terminal and the second output terminal,
wherein a gate electrode of the fifth transistor is connected to the first node, and a gate electrode of the sixth transistor is connected to the first input terminal.

16. The display device according to claim 15, wherein the second clock signal is supplied to the i-th stage circuit via the second output terminal when the second transmission gate is turned on.

17. The display device according to claim 8, wherein the scan lines comprise first scan lines and second scan lines respectively at the horizontal lines, and
wherein the scan driver comprises a first scan driver configured to drive the first scan lines, and a second scan driver configured to drive the second scan lines.

18. The display device according to claim 17, wherein the clock signal comprises at least one write clock signal for driving the first scan driver and at least one compensation clock signal for driving the second scan driver.

19. The display device according to claim 18, wherein the clock controller comprises a plurality of clock selection circuits, the first scan driver comprises a plurality of write stage circuits, and the second scan driver comprises a plurality of compensation stage circuits, and
when the emission control signal is supplied to an i-th (i is a natural number) emission control line, an i-th clock selection circuit at an i-th horizontal line is configured to supply the write clock signal to an i-th write stage circuit at the i-th horizontal line, and configured to supply the compensation clock signal to an i-th compensation stage circuit at the i-th horizontal line.

20. The display device according to claim 19, wherein when the emission control signal is not supplied to the i-th emission control line, the i-th clock selection circuit does not supply the write clock signal to the i-th write stage circuit and does not supply the compensation clock signal to the i-th compensation stage circuit.

21. The display device according to claim 19, wherein the i-th clock selection circuit comprises:
a first input terminal connected to the i-th emission control line;
an inverter connected to the first input terminal;
a first controller connected to the first input terminal and a first node which is an output node of the inverter, and configured to supply the write clock signal to the i-th write stage circuit when the emission control signal is supplied to the first input terminal; and
wherein a second controller connected to the first input terminal and the first node, and configured to supply the compensation clock signal to the i-th compensation stage circuit when the emission control signal is supplied to the first input terminal.

22. The display device according to claim 21, wherein the inverter comprises a P-type first transistor and an N-type second transistor connected in series between a first power source and a second power source having a voltage lower than that of the first power source, and
a gate electrode of the first transistor and a gate electrode of the second transistor are connected to the first input terminal.

23. The display device according to claim 21, wherein the first controller comprises:
a first transmission gate connected between a first output terminal and a second input terminal connected to a first clock line configured to receive a first write clock signal, and is configured to turn on when the emission control signal is supplied to the first input terminal; and
a second transmission gate connected between a second output terminal and a third input terminal connected to a second clock line configured to receive a second write clock signal, and is configured to turn on when the emission control signal is supplied to the first input terminal.

24. The display device according to claim 22, wherein the second controller comprises:
a first transmission gate connected between a first output terminal and a second input terminal connected to a first clock line configured to receive a first compensation clock signal, and is configured to turn on when the emission control signal is supplied to the first input terminal; and
a second transmission gate connected between a second output terminal and a third input terminal connected to a second clock line configured to receive a second compensation clock signal, and is configured to turn on when the emission control signal is supplied to the first input terminal.

25. A display device comprising:
pixels connected to first scan lines, second scan lines, emission control lines, and data lines;
a first scan driver configured to supply a first scan signal to the first scan lines;
a second scan driver configured to supply a second scan signal to the second scan lines;
an emission driver configured to supply an emission control signal to the emission control lines;
a first clock controller configured to receive at least one write clock signal to drive the first scan driver and is configured to determine whether to supply the write clock signal in response to the second scan signal; and
a second clock controller configured to receive at least one compensation clock signal or driving the second scan driver and is configured to determine whether to supply the compensation clock signal in response to the emission control signal.

26. The display device according to claim 25, wherein the first clock controller is further configured to sequentially receive the second scan signal in a horizontal line unit, and configured to output the write clock signal in the horizontal line unit in response to the second scan signal.

27. The display device according to claim 26, wherein the first clock controller comprises a clock selection circuit at the horizontal line, and
an i-th (i is a natural number) clock selection circuit at an i-th horizontal line comprises:
an inverter configured to invert an i-th second scan signal; and
a controller configured to output the write clock signal to the first scan driver when the i-th second scan signal and an output signal of the inverter are input, and does not output the write clock signal in other cases.

28. The display device according to claim 25, wherein the second clock controller is further configured to sequentially receive the emission control signal in a horizontal line unit and configured to output the compensation clock signal in the horizontal line unit in response to the emission control signal.

29. The display device according to claim 28, wherein the second clock controller comprises a clock selection circuit at the horizontal line, and
an i-th (i is a natural number) clock selection circuit at an i-th horizontal line comprises:
an inverter configured to invert an i-th emission control signal; and
a controller configured to output the compensation clock signal to the second scan driver when the i-th emission control signal and an output signal of the inverter are input, and does not output the compensation clock signal in other cases.

30. A method of driving a display device, the method comprising:
sequentially supplying an emission control signal to pixels;
outputting a clock signal in a horizontal line unit when the emission control signal is input; and
sequentially supplying a scan signal in response to the clock signal input in the horizontal line unit.
